(19) United States
(12) Patent Application Publication
(10) Pub. No.: US 2021/0295224 A1
(43) Pub. Date: Sep. 23, 2021

(54) UTILIZING A REQUESTOR DEVICE FORECASTING MODEL WITH FORWARD AND BACKWARD LOOKING QUEUE FILTERS TO PRE-DISPATCH PROVIDER DEVICES

(71) Applicant: Lyft, Inc., San Francisco, CA (US)

(72) Inventors: Maxim Dorofiyenko, El Cerrito, CA (US); Nir Even Chen, Redwood City, CA (US); John Stevens Markevitch, Palo Alto, CA (US); Mohammad Ali Motie Share, San Francisco, CA (US); Allen Lamson Nguyen, Long Island City, NY (US); Lily Sierra, San Francisco, CA (US)

(21) Appl. No.: 16/827,305

(22) Filed: Mar. 23, 2020

(51) Int. Cl. G06Q 10/06; G06N 5/04

(52) U.S. Cl. CPC G06Q 10/06311; G06N 20/00; G06N 5/04

(57) ABSTRACT

The present disclosure relates to systems, non-transitory computer-readable media, and methods for intelligently pre-dispatching candidate provider devices to a geographic area by utilizing a pre-dispatch model accounting for forecasted transportation requests. For example, the disclosed systems can determine how many candidate provider devices to pre-dispatch to a geographic area based on a variety of inputs, including a projected requestor device queue, a projected provider device queue, and/or a queue capacity. In particular, the disclosed systems can utilize a look-ahead model and a look-behind model to compare a queue capacity with projected provider device queues corresponding to estimated times of arrival for one or more candidate provider devices. If the projected provider device queues comport with the queue capacity according to both the look-ahead model and the look-behind model, the disclosed systems can proceed with pre-dispatching the candidate provider device to the geographic area.

### BACKGROUND

Recent years have seen significant development in transportation matching systems that utilize web and mobile applications to manage real-time on-demand transportation requests from requestor devices. For example, on-demand transportation matching systems can match provider devices with requestor devices to provide transportation across a variety of geographic locations. To illustrate, on-demand transportation matching systems can position provider devices at airports and other venues with high requestor density (e.g., sports stadiums, concert halls, tourist locations, etc.). Many of these high density locations include designated areas where provider devices can await while the on-demand transportation matching system matches and dispatches the provider devices to requestor devices. Although on-demand transportation matching systems can dispatch provider devices at congested venues in managing on-demand transportation requests from requestor devices, such systems suffer from a number of technical problems, particularly in accuracy, efficiency, and flexibility of implementing computer systems.

### BRIEF SUMMARY

Embodiments of the present disclosure provide benefits and/or solve one or more of the foregoing or other problems in the art with systems, non-transitory computer-readable media, and methods for intelligently pre-dispatching candidate provider devices utilizing a pre-dispatch model that utilizes forward-looking digital queue filters reflecting forecasted transportation requests and backward-looking provider device dispatch remedial conflict filters. For example, the disclosed systems can analyze candidate provider devices and intelligently pre-dispatch a set of provider devices to a geographic location (e.g., an airport curb or waiting zone) before requestor devices have initiated transportation requests. Specifically, the disclosed systems can utilize a requestor device forecasting model to determine transportation requests (e.g., an estimated requestor queue) at an estimated time of arrival after dispatch of a provider device. Utilizing a look-ahead model and the estimated requestor queue, the disclosed systems can determine a projected provider device queue and determine whether a candidate provider device can expect sufficient availability at the geographic location upon arrival. Additionally, utilizing a look-behind model, the disclosed systems can determine whether pre-dispatching the candidate provider device will interfere with previously dispatched provider devices when those devices arrive at the geographic location. In this manner, the disclosed systems can efficiently, flexibly, and accurately pre-dispatch provider devices to a congested location (e.g., an airport curb) to accommodate future requests from requestor devices.

Additional features and advantages of one or more embodiments of the present disclosure are outlined in the following description.

### BRIEF DESCRIPTION OF THE DRAWINGS

The detailed description provides one or more embodiments with additional specificity and detail through the use of the accompanying drawings, as briefly described below.

FIG. 1 illustrates a diagram of a system including a flex forecasting pre-dispatch system in accordance with one or more embodiments.

FIG. 2 illustrates a schematic diagram of implementing a flex forecasting pre-dispatch system in accordance with one or more embodiments.

FIGS. 3A-3D illustrate schematic diagrams for determining whether to pre-dispatch a candidate provider device to a geographic area in accordance with one or more embodiments.

FIG. 4 illustrates a flex forecasting pre-dispatch system comparing simulated performance metrics to select a pre-dispatch model in accordance with one or more embodiments.

FIG. 5 illustrates an example schematic diagram of a flex forecasting pre-dispatch system in accordance with one or more embodiments.

FIG. 6 illustrates a flowchart of a series of acts for determining to pre-dispatch a candidate provider device to a geographic area in accordance with one or more embodiments.

FIG. 7 illustrates a block diagram of an example computing device for implementing one or more embodiments of the present disclosure.

FIG. 8 illustrates an example network environment of a transportation matching system in accordance with one or more embodiments.

### DETAILED DESCRIPTION

This disclosure describes one or more embodiments of a flex forecasting pre-dispatch system that utilizes a requestor device forecasting model in conjunction with forward and backward looking queue filters to intelligently pre-dispatch candidate provider devices. For example, the flex forecasting pre-dispatch system can utilize a requestor device forecasting model to project the number of requestor devices at an estimated time of arrival (ETA) for a candidate provider device (e.g., at an airport curb). Based on the projected number of transportation requests at the ETA of the candidate provider device, the flex forecasting pre-dispatch system can predict a number of provider devices in queue upon arrival at the airport curb. The flex forecasting pre-dispatch system can also apply a forward-looking queue filter to dispatch the candidate provider device by determining whether the predicted number of providers at the airport curb for the ETA of the candidate provider device is less than a queue capacity. Moreover, the forecasting pre-dispatch system can apply a backward-looking queue filter by analyzing earlier pre-dispatched provider devices. Specifically, the flex forecasting pre-dispatch system can analyze another ETA of an earlier pre-dispatched candidate provider device to determine whether sending the candidate provider device will allow the earlier pre-dispatched candidate provider to arrive at a queue of provider devices that is less than a queue capacity. In this manner, the flex forecasting pre-dispatch system can accurately, efficiently, and flexibly pre-dispatch provider devices to satisfy projected transportation requests from a geographic area.

As mentioned above, the flex forecasting pre-dispatch system can utilize a requestor device forecasting model in identifying candidate provider to pre-dispatch to a geographic area. In particular, the flex forecasting pre-dispatch system can determine ETAs for a variety of candidate provider devices and utilize the requestor device forecasting model to determine a projected requestor device queue for the geographic area at the various ETAs. For example, the flex forecasting pre-dispatch system can utilize a machine learning model to predict a number of requestor devices and corresponding outstanding transportation requests within a time window corresponding to the ETAs. To illustrate, for a candidate provider device ten minutes away from an airport pick-up curb, the flex forecasting pre-dispatch system can analyze the geographic region, time, current requestor devices, and other features utilizing the requestor device forecasting model to identify the number of transportation requests and the requestor device queue in ten minutes.

Based on a projected requestor device queue, the flex forecasting pre-dispatch system can utilize a look-ahead model and/or a look-behind model to determine whether to pre-dispatch a candidate provider device to the geographic area. For example, utilizing the look-ahead model, the flex forecasting pre-dispatch system can determine whether a provider device queue will accommodate the candidate provide device at the ETA. Specifically, the flex forecasting pre-dispatch system can utilize the predicted requestor device queue to determine a provider device queue at the ETA. The flex forecasting pre-dispatch system can compare the projected requestor device queue with a queue threshold (e.g., as a maximum curb capacity). In some embodiments, the flex forecasting pre-dispatch system will pre-dispatch a candidate provider device if the projected requestor device queue at the ETA for the candidate provider devices satisfies the queue threshold.

As mentioned, in some embodiments, the flex forecasting pre-dispatch system utilizes a look-behind model to pre-dispatch candidate provider devices. For example, the flex forecasting pre-dispatch system can utilize the look-behind model to determine whether dispatching a candidate provider device will interfere with other provider devices already dispatched to the geographic location. For instance, in one or more embodiments, the flex forecasting pre-dispatch system determines a projected provider device queue for a previously dispatched provider device. Specifically, the flex forecasting pre-dispatch system can determine a projected queue for the previously dispatched provider device, in the event the candidate provider device is also dispatched. The flex forecasting pre-dispatch system can compare the projected requestor queue (at the ETA of the earlier pre-dispatched provider device) with a queue capacity to determine whether to dispatch the current candidate provider device. In this manner, the flex forecasting pre-dispatch system can determine whether, in pre-dispatching a candidate provider device, there is still sufficient availability for an earlier pre-dispatched provider device at the geographic location.

As just discussed, the flex forecasting pre-dispatch system can utilize various pre-dispatch models to position provider devices at geographic locations to match with requestor devices. In some implementations, the flex forecasting pre-dispatch system selects a particular pre-dispatch model utilizing simulated performance metrics. In particular, the flex forecasting pre-dispatch system can execute simulations using different pre-dispatch models to determine simulated performance metrics for each pre-dispatch model. Based on comparing the simulated performance metrics, the flex forecasting pre-dispatch system can select which pre-dispatch model to implement. Additionally or alternatively, the flex forecasting pre-dispatch system can switch between pre-dispatch models. For example, the flex forecasting pre-dispatch system can select/switch between pre-dispatch models that utilize different parameters, such as queue capacity, forecasting intervals, ETA call intervals, etc. The flex forecasting pre-dispatch system can also select between pre-dispatch models that utilize forecasting and pre-dispatch models that do not use forecasting.

As briefly mentioned above, a number of technical problems exist with on-demand transportation matching systems, particularly in accuracy, efficiency, and flexibility of implementing computer systems. For example, conventional on-demand transportation matching systems often utilize static models that account for current conditions in dispatching provider devices. Specifically, these static models determine the number of provider devices to send to a given location primarily based on a current shortfall of provider devices relative to requestor devices at the given location. This approach is rigid and inflexible in positioning provider devices because circumstances often change in utilizing real-time on-demand applications across client devices. Indeed circumstances can change dramatically as provider devices travel to pick-up locations corresponding to requestor devices at congested venues.

Due at least in part to the static models of conventional on-demand transportation matching systems, such systems also suffer from decreased accuracy. Specifically, conventional on-demand matching systems often overcompensate or undercompensate for the number of requestor devices at congested venues. Indeed, positioning provider devices at such venues is often modeled as a dynamic, double-ended queue problem that system computing devices utilize significant resources in an attempt to resolve. Inaccuracies in overcompensating or undercompensating lead to increased computational resources for remedying the resulting effects in positioning, matching, and managing provider devices and requestor devices. The waste of system resources is only exacerbated by the complexity of managing digital cancellations from both provider devices and requestor devices that fluctuate in real-time based on the accuracy of the on-demand transportation matching systems.

For example, based on inaccurately sending too few provider devices to a given location (thereby increasing wait time for requestor devices), some conventional on-demand transportation matching systems generate/process excess communications to and/or from a transportation matching server for informing requestor devices as wait times change, managing increased requestor device cancellation requests, and/or re-matching provider devices and requestor devices in response to these cancellations. Similarly, based on inaccurately sending too many provider devices to a given location (thereby increasing wait time for provider devices), conventional on-demand transportation matching systems often generate/process excess communications to and/or from a transportation matching server informing provider devices, managing increased provider device cancellation requests, cancelling or otherwise revising dispatches due to insufficient real estate (e.g., waiting zone spots), and/or re-routing and re-matching provider devices in response to provider-device cancellations.

Additionally, conventional on-demand transportation matching systems suffer from decreased model flexibility. Due at least in part to the static models as described above, conventional systems suffer from decreased responsiveness to sudden fluctuations (e.g., surges and lulls) in transportation requests that occur on hourly, daily, weekly, monthly, and/or seasonal bases at given locations. Accordingly, conventional on-demand transportation matching systems are more rigid and typically require longer periods of time to adequately adjust provider devices at a given location. Such lag time of conventional systems can also increase with persistent fluctuation in transportation requests, thereby further perpetuating the system inefficiencies described above.

In view of the foregoing, the flex forecasting pre-dispatch system can provide several technical advantages relative to conventional systems. For example, the flex forecasting pre-dispatch system can utilize dynamic models that can consider forecasted conditions at a geographic area in determining whether to pre-dispatch a candidate provider device to the geographic area. Specifically, unlike some models that rely predominantly on static constants and current conditions (e.g., current requestor device queues and current provider device queues), the flex forecasting pre-dispatch system can predict projected requestor device queues at estimated times of arrival for intelligently pre-dispatching candidate provider devices to the geographic area.

In turn, the flex forecasting pre-dispatch system can improve pre-dispatching accuracy relative to conventional systems. Unlike some models that overcompensate or undercompensate for a requestor device queue at a geographic area, the flex forecasting pre-dispatch system can improve or resolve the double-ended queue problem by utilizing a requestor device forecasting model in combination with forward and/or backward looking queue filters. In particular, the flex forecasting pre-dispatch system can utilize the requestor device forecasting model to generate a projected requestor device queue at times corresponding to ETAs of candidate provider devices. Then, utilizing a look-ahead model and/or a look-behind model, the flex forecasting pre-dispatch system can avoid sending too few candidate provider devices or too many candidate provider devices to the geographic area.

By more accurately pre-dispatching candidate provider devices, the flex forecasting pre-dispatch system can also decrease computational resources. For example, by utilizing a requestor device forecasting model with look-ahead model and/or look-behind model, the flex forecasting pre-dispatch system can reduce excess communications to and/or from a transportation matching server for informing requestor devices regarding increased wait times, managing device cancellation requests, and/or re-matching of provider devices and requestor devices in response these cancellations. Moreover, the flex forecasting pre-dispatch system can also reduce resources dedicated to informing candidate provider devices, managing increased provider device cancellations, cancelling or revising dispatches due to insufficient space within a geographic location, and/or re-routing and re-matching provider devices in response to cancellations.

Additionally, the flex forecasting pre-dispatch system improves model flexibility in comparison to conventional systems. For example, unlike some models that suffer from decreased responsiveness due to model rigidity, the flex forecasting pre-dispatch system is more flexible and can respond responding more quickly to sudden surges and lulls in transportation requests. Specifically, by utilizing the requestor device forecasting model in addition to the look-ahead model and the look-behind model, the flex forecasting pre-dispatch system leverages flexibility to decrease lag time in harmonizing a provider device queue and a requestor device queue at a geographic area.

As illustrated by the foregoing discussion, the present disclosure utilizes a variety of terms to describe features and benefits of the flex forecasting pre-dispatch system. Additional detail is now provided regarding the meaning of these terms. For example, as used herein, the term “pre-dispatch model” refers to a model for positioning provider devices at a geographic area (even before receiving transportation requests from a requestor device seeking transportation services via the provider device). In particular, a pre-dispatch model can include a model that determines how many and which candidate provider devices to pre-dispatch to a geographic area at a given time.

Additionally, as used herein, the term “candidate provider device” refers to a computing device associated with a transportation provider and/or transportation vehicle. In particular, a candidate provider device can include a computing device corresponding to a transportation vehicle (e.g., an autonomous vehicle or vehicle operated by a driver) that is available to be dispatched (e.g., sent) to a location and/or provider device.

Relatedly, as used herein, the term “provider device queue” refers to a number of provider devices. In particular, a provider device queue can include a number of pre-dispatched provider devices positioned at the geographic area (e.g., a curb queue). In some cases, a provider device queue can denote an order or sequence of provider devices (e.g., based on an order of pre-dispatching to the geographic area). For example, the flex forecasting pre-dispatch system may match provider devices, in a sequential order according to the provider device queue, to corresponding requestor devices. Additionally, in some embodiments, a “current provider device queue” reflects a number (e.g., a virtual line or sequence) of provider devices at a present moment in time (e.g., at time=t). Further, in some embodiments, a “projected provider device queue” reflects a provider device queue estimated for some future moment in time (e.g., at time=tₓ, where tₓ is after t). Also related, an “in-transit provider device queue” refers to a number of pre-dispatched provider devices in-transit (i.e., en route) to the geographic area.

Similarly, as used herein, the term “requestor device queue” refers to a number of requestor devices. In particular, a requestor device queue includes requestor devices at a geographic area (e.g., requestor devices associated with a transportation request). In some cases, a requestor device queue can denote an order or sequence of requestor devices (e.g., based on an order of requesting transport from the geographic area, a destination location, a ride-share mode, etc.). For example, the flex forecasting pre-dispatch system may match requestor devices, in a sequential order according to the requestor device queue, to corresponding provider devices. In some embodiments, a “current requestor device queue” reflects a number (e.g., a virtual line or sequence) of requestor devices at a present moment in time (e.g., at time=t). Further, in some embodiments, a “projected requestor device queue” reflects a requestor device queue predicted for some future moment in time (e.g., at time t=t_{future}, where t_{future} is after t). In some implementations, a projected requestor device queue corresponds to a predicted requestor device queue for an estimated time of arrival (“ETA”) of a candidate provider device at a geographic area. In this case, “ETA” may refer to an estimated time to arrival (e.g., at time=t+ETAᵢ, where ETAᵢ refers to an estimated time to arrival for a given candidate provider device, such as six minutes).

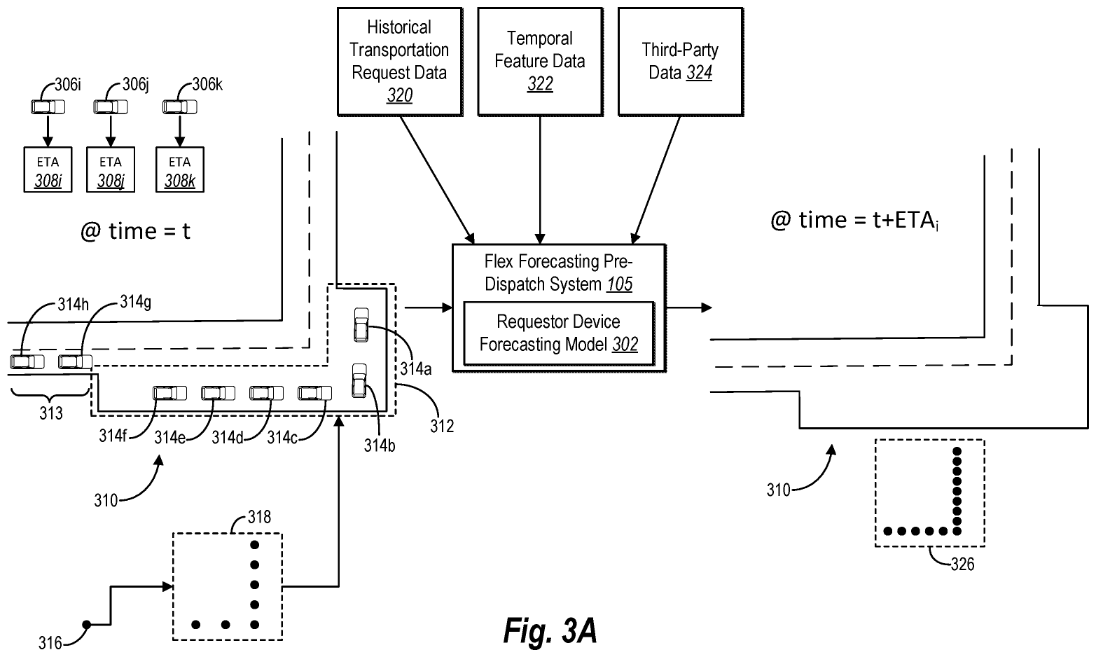

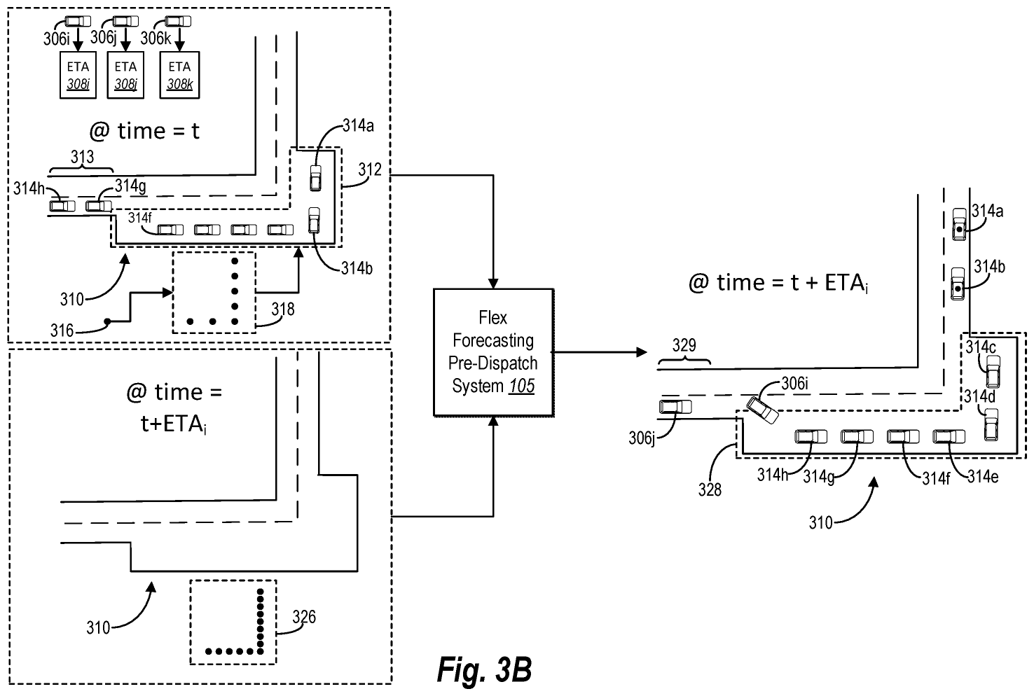

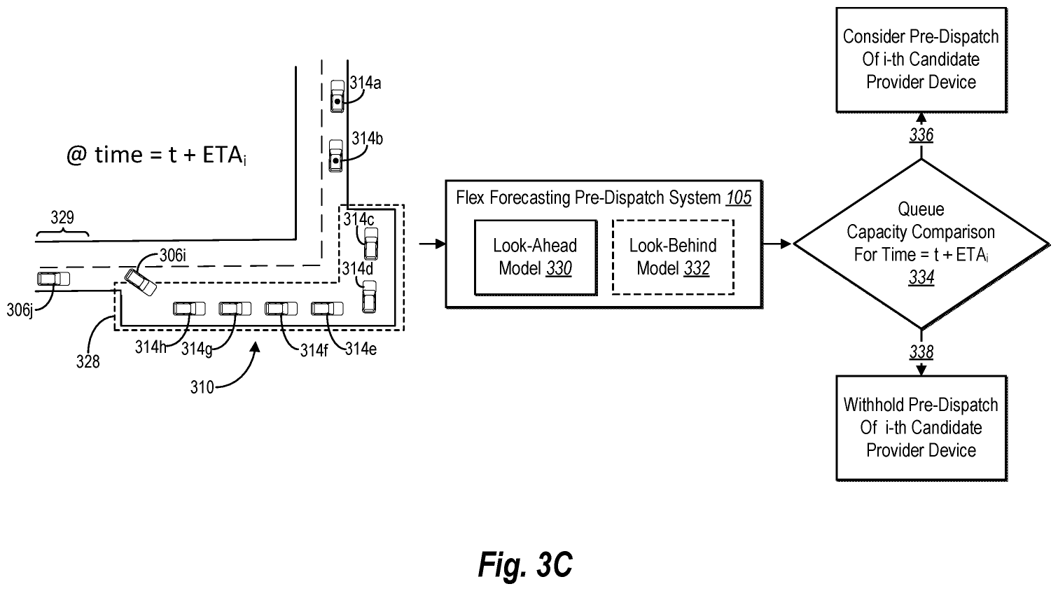

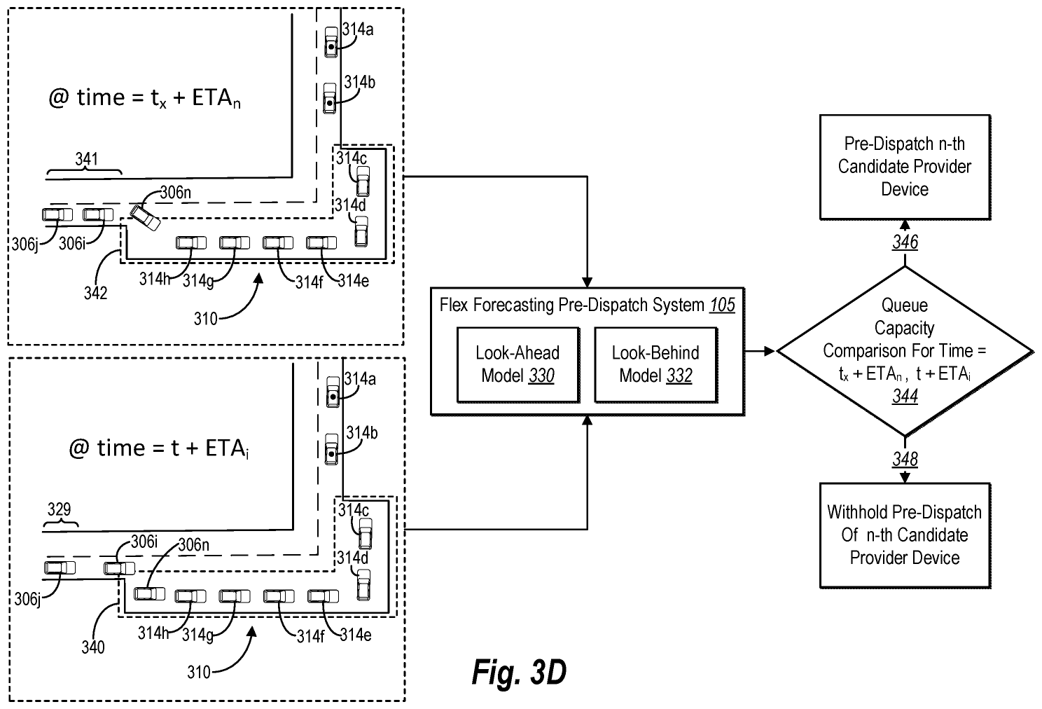

Further, as used herein, the term “requestor device forecasting model” refers to a model for predicting a number of future requestor devices. In particular, the requestor device forecasting model can predict a number of requestor devices that at a future time will transmit transportation requests (e.g., a number of requestor devices yet to be picked up for transport). For example, in some embodiments, the requestor device forecasting model can include one or more computer-implemented algorithms (e.g., heuristic algorithms or machine learning models) for dynamically forecasting a number of future requestor devices based on various input data as described further below (e.g., in relation to FIG. 3A).

One example of such input data includes “historical transportation request data,” which as referred to herein, comprises data that reflects past transportation requests. For example, historical transportation request data can include the rate at which requestor devices have previously entered a requestor device queue. For example, historical transportation request data can include a number of transportation requests for specific intervals of time (e.g., recent transportation requests in the past zero to five minutes, or at a similar time period the previous week).

In addition, as used herein, the term “queue capacity” refers to a threshold number, score, or a range corresponding to a queue. In particular, a queue capacity can include a variable, predefined number of provider devices at a geographic area (e.g., a location, GPS coordinate, geohash, facility, venue, airport, street, curb, zone, stage, meter, etc.). For example, the queue capacity may include an airport curb capacity (e.g., twenty vehicles), a maximum number of provider devices, etc. The flex forecasting pre-dispatch system may utilize different queue capacities for different pre-dispatch models, different ride types, etc.

As used herein, the term “look-ahead model” refers to a model for predicting conditions at a geographic area. In particular, a look-ahead model can determine a projected provider device queue for a given future time and compare the projected provider device queue to a queue capacity. For example, utilizing a look-ahead model, the flex forecasting pre-dispatch system can consider pre-dispatching a candidate provider device to a geographic area if a projected provider device queue corresponding to an ETA of the candidate provider device at the geographic area is less than a queue capacity. In this manner, a look-ahead model can figuratively look ahead to predict whether the projected provider device queue will have sufficient availability for a given candidate provider device upon its arrival at the geographic area.

As further used herein, the term “look-behind model” refers to a model for predicting conditions at a geographic area in relation to a provider device already dispatched to the geographic area. For example, utilizing a look-behind model, the flex forecasting pre-dispatch system can consider pre-dispatching a candidate provider device to a geographic area if a modified projected provider device queue for a previously dispatched provider device is less than a queue capacity. In this manner, a look-behind model can check to see that, in pre-dispatching a candidate provider device to a geographic area, there will be sufficient availability in the provider device queue for another candidate provider device previously pre-dispatched to the geographic area.

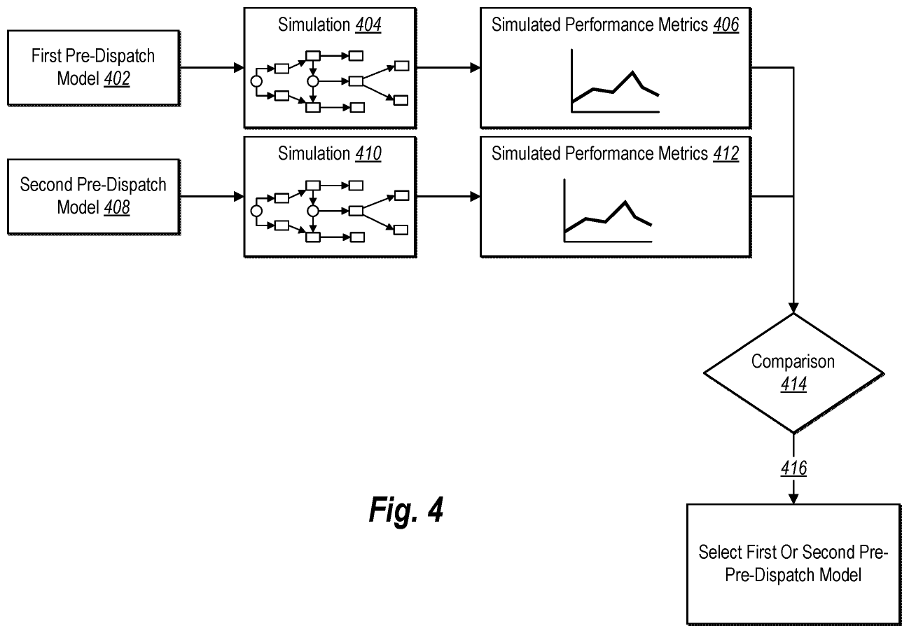

As also used herein, the term “simulation” refers to a computer algorithm for virtually simulating performance of a pre-dispatch model. In particular, the flex forecasting pre-dispatch system can execute a simulation for generating various simulated performance metrics (i.e., performance indicators that quantify certain areas of performance for a pre-dispatch model). For example, based on executing a simulation of a pre-dispatch model, the flex forecasting pre-dispatch system can generate simulated performance metrics such as average requestor wait time, size (or number) of the requestor device queue over a period of time, average number of transportation requests per flight arrival, a conversion metric, throughput metric (e.g., pickups/minute), inference metrics (e.g., relating to other on-demand provider devices), a congestion metric, etc. as described more below in relation to FIG. 4. Based on one or more simulated performance metrics, the flex forecasting pre-dispatch system can compare pre-dispatch models and select a pre-dispatch model to implement.

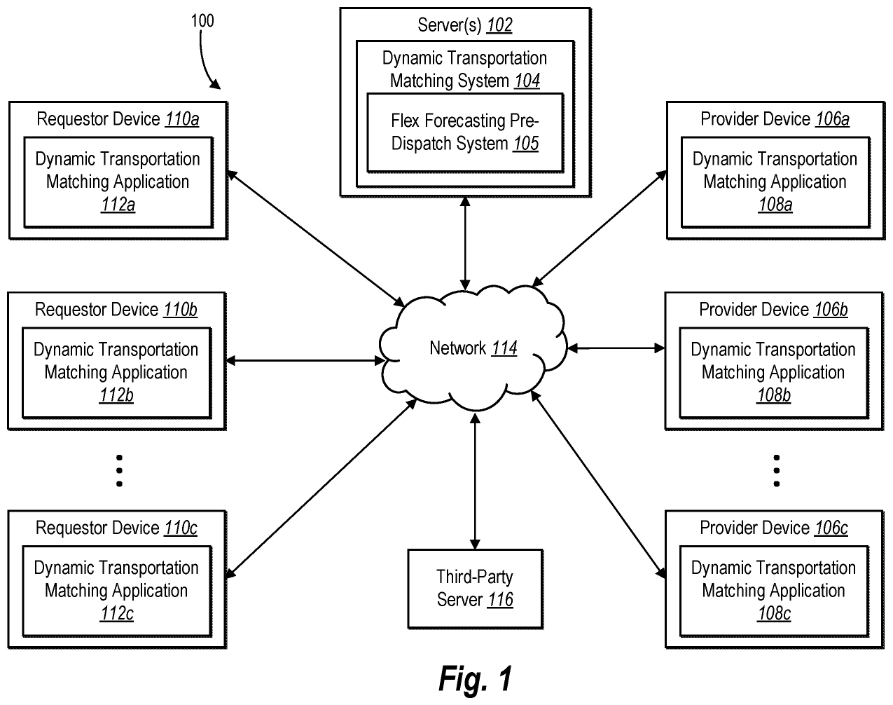

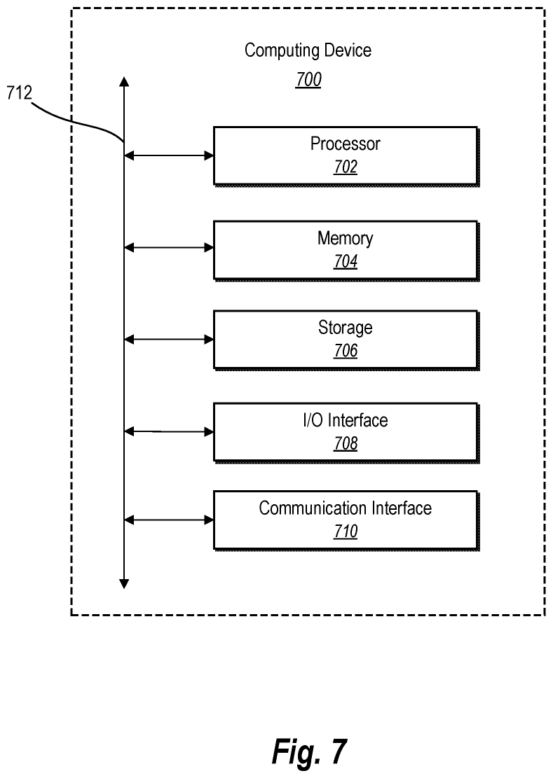

Additional detail will now be provided in relation to illustrative figures portraying example embodiments and implementations of the flex forecasting pre-dispatch system. For example, FIG. 1 illustrates a computing system environment (or “environment”) 100 for implementing a flex forecasting pre-dispatch system 105 in accordance with one or more embodiments. As shown in FIG. 1, the environment 100 includes server(s) 102, provider devices 106a-106n, requestor devices 110a-110n, a network 114, and a third-party server 116. Each of the components of the environment 100 can communicate via the network 114, and the network 114 may be any suitable network over which computing devices can communicate. Example networks are discussed in more detail below in relation to FIG. 7.

As shown in FIG. 1, the environment 100 includes the provider devices 106a-106n (collectively, the provider devices 106). Similarly, the environment 100 includes the requestor devices 110a-110n (collectively, the requestor devices 110). The provider devices 106 and the requestor devices 110 can each be one of a variety of computing devices, including a smartphone, tablet, smart watch, smart television, desktop computer, laptop computer, virtual reality device, augmented reality device, or other computing device as described in relation to FIG. 7. Additionally or alternatively, in some embodiments, one or more of the provider devices 106 are attached to (or integrated within) transportation vehicles (e.g., autonomous transportation vehicles). Furthermore, FIG. 1 illustrates multiple provider devices 106 and multiple requestor devices 110. However, in some embodiments the environment 100 can include a single provider device 106 and/or a single requestor device 110.

In addition, the provider devices 106 and the requestor devices 110 can further communicate with the server(s) 102, including the dynamic transportation matching system 104 and the flex forecasting pre-dispatch system 105 via the network 114. For example, in response to transportation requests from the requestor devices 110, the dynamic transportation matching system 104 can communicate with the provider devices 106 and/or the requestor devices 110 via the network 114 to provide various communications (e.g., regarding pre-dispatch, matching, pickup, etc.).

As shown, each of the provider devices 106 and the requestor devices 110 include corresponding dynamic transportation matching applications 108a-108n and 112a-112n, respectively. In particular, the dynamic transportation matching applications 108a-108n and 112a-112n (collectively, applications 108 and applications 112, respectively) may be a web application, a native application installed on the provider devices 106 and the requestor devices 110 (e.g., a mobile application, a desktop application, etc.), or a cloud-based application where part of the functionality is performed by the server(s) 102. The applications 108 and the applications 112 can present or display information to users respectively associated with the provider devices 106 and the requestor devices 110, including information relating to transportation requests, pre-dispatch, matching, pickup, etc. as described in more detail below. As an example, the dynamic transportation matching application 108a can cause the provider device 106a to communicate with the dynamic transportation matching system 104 for receiving instructions regarding pre-dispatch to a geographical area, navigation to a pickup location to pick up a requestor, etc.

As illustrated in FIG. 1, the environment 100 includes the server(s) 102. The server(s) 102 may execute, generate, store, receive, and transmit electronic data, such as executable instructions for utilizing a pre-dispatch model to position the provider devices 106 at a geographic area corresponding to the requestor devices 110. For example, the server(s) 102 may receive transportation requests from the requestor devices 110 at the geographic area. In turn, the server(s) 102 can transmit data associated with the transportation requests to one or more components in the environment 100. For example, the server(s) 102 can send the transportation requests to the flex forecasting pre-dispatch system 105 for forecasting purposes and/or for pre-dispatching candidate provider devices to the geographic area. Additionally or alternatively, for example, the server(s) 102 may send location data and/or ETA data for one or more of the provider devices 106 to the flex forecasting pre-dispatch system 105 to determine how many and which candidate provider devices the flex forecasting pre-dispatch system 105 should appropriately pre-dispatch to the geographic area.

In some embodiments, the server(s) 102 and the third-party server 116 can exchange digital data. Utilizing the exchanged digital data, for example, the flex forecasting pre-dispatch system 105 can then generate a projected requestor device queue. In some implementations for instance, the server(s) 102 may obtain flight information from the third-party server 116 to help predict or forecast transportation requests at an airport. Additionally or alternatively, in some embodiments, the third-party server 116 (whether the same or a different third-party server) may include navigation information, such as location-based ETA data. In an example implementation, the server(s) 102 can communicate with the provider devices 106 to obtain location data. In turn, the server(s) 102 can then communicate with the third-party server 116 to determine ETAs for the provider devices 106 at a geographic location based on the obtained location data. In these or other embodiments, the third-party server 116 comprises a content server and/or a data collection server. Additionally or alternatively, the third-party server 116 can comprise an application server, a communication server, a web-hosting server, a social networking server, or a digital content management server.

Although FIG. 1 depicts the flex forecasting pre-dispatch system 105 located on the server(s) 102, in some embodiments, the flex forecasting pre-dispatch system 105 may be implemented by one or more other components of the environment 100 (e.g., by being implemented entirely or in part at one or more of the other components). For example, the flex forecasting pre-dispatch system 105 may be implemented in whole, or in part, by the provider devices 106, the requestor devices 110, and/or the third-party server 116. In another example implementation, the flex forecasting pre-dispatch system 105 may perform one or more acts of the present disclosure described in conjunction with the dynamic transportation matching system 104. Additionally, or alternatively, the dynamic transportation matching system 104 may perform one or more acts of the present disclosure described in conjunction with the flex forecasting pre-dispatch system 105.

As shown in FIG. 1, the flex forecasting pre-dispatch system 105 is implemented as part of a dynamic transportation matching system 104 located on the server(s) 102. The dynamic transportation matching system 104 can organize, manage, and/or execute pre-dispatch of candidate provider devices to a geographic area. Additionally or alternatively, the dynamic transportation matching system 104 can match provider devices 106 in a provider device queue at the geographic area with corresponding requestor devices 110 at the geographic area. Based on the matching for example, a provider device 106a can pick up one or more of the requestor devices 110 for transport according to one or more transportation requests. As another example, the dynamic transportation matching system 104 can utilize the flex forecasting pre-dispatch system 105 to simulate pre-dispatch models, store simulated performance metrics generated from simulated pre-dispatch models, and/or implement certain pre-dispatch models at certain geographic areas (or other pre-dispatch models at other geographic areas).

Although not illustrated in FIG. 1, in some embodiments, the environment 100 may have a different arrangement of components and/or may have a different number or set of components altogether. For example, in certain implementations, some or all of the provider devices 106 are computing devices unassociated with a human transportation provider and constitute autonomous transportation vehicles—that is, a self-driving vehicle that includes computer components and accompanying sensors for driving without manual-provider input from a human operator. As a further example, in some embodiments, one or more of the provider devices 106 include a hybrid self-driving vehicle with both self-driving functionality and some human operator interaction.

When a provider device is an autonomous vehicle or a hybrid self-driving vehicle, the provider device may further include additional components not depicted in FIG. 1. Such components may include location components, one or more sensors by which the autonomous vehicle navigates, and/or other components necessary to navigate without a provider (or with minimal interactions with a provider). Additionally, or alternatively, the provider devices 106 may be subcomponents of a vehicle computing system. Regardless of its form, the provider devices 106 may include various sensors, such as a GPS locator, an inertial measurement unit, an accelerometer, a gyroscope, a magnetometer, and/or other sensors, from which the dynamic transportation matching system 104 can access information, such as location data.

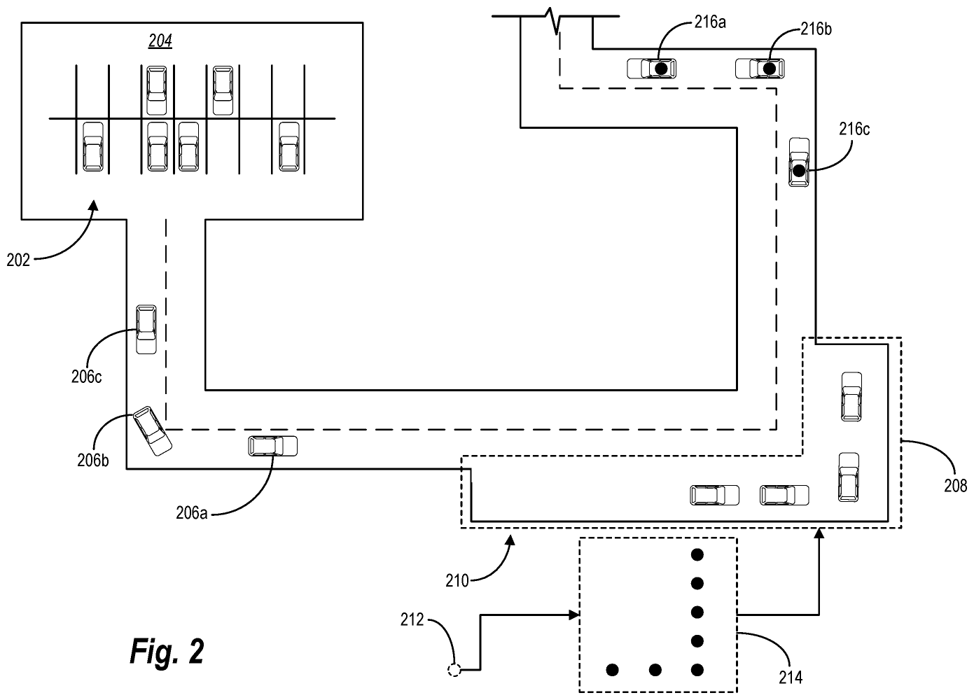

As mentioned above, the flex forecasting pre-dispatch system 105 can intelligently pre-dispatch candidate provider devices to a geographic area corresponding to requestor devices. FIG. 2 illustrates a schematic diagram of implementing a flex forecasting pre-dispatch system in accordance with one or more embodiments of the present disclosure. In particular, FIG. 2 illustrates among a requestor device queue 214 and a provider device queue 208 at a geographic area 210.

As shown in FIG. 2, candidate provider devices 202 are positioned at a staging lot 204. The candidate provider devices 202 are available for pre-dispatch to the geographic area 210. Though the staging lot 204 is, by way of example, depicted as a parking lot in FIG. 2, in some embodiments, the staging lot 204 is not necessarily a singular designated area. Rather, the staging lot 204 can more generally refer to a geographic region that includes a candidate provider device pool of available candidate provider devices 202 available for pre-dispatch to the geographic area 210. For instance, the staging lot 204 may include a geographic region defined by some distance threshold or ETA threshold relative to the geographic area 210.

Furthermore, unlike other systems, the flex forecasting pre-dispatch system 105 can pre-dispatch one or more of the candidate provider devices 202 (illustrated as pre-dispatched provider devices 206a-206c). For example, the flex forecasting pre-dispatch system 105 can predict requestor devices 212 not yet part of the requestor device queue 214. In forecasting the requestor devices 212, the flex forecasting pre-dispatch system 105 can predict what the requestor device queue 214 will be at a future point in time, and in turn, predict what the provider device queue 208 will be at that future point in time. Based on this forecasted data, the flex forecasting pre-dispatch system 105 can flexibly and responsively pre-dispatch one or more of the candidate provider devices 202 (e.g., as shown with the pre-dispatched provider devices 206a-206c) such that there is not an oversupply or undersupply of provider devices at the provider device queue 208 at any given time. For instance, prior to receiving a transportation request from a requestor device (or identifying a match between a requestor device and the provider device), the flex forecasting pre-dispatch system 105 can intelligently dispatch a candidate provider device to the geographic area (i.e., a provider that ultimately provides transportation services for the requestor device).

By forecasting the requestor devices 212, the flex forecasting pre-dispatch system 105 can also ensure that when the pre-dispatched provider devices 206a-206c arrive at the provider device queue 208 for the geographic area 210, the provider device queue 208 will have sufficient availability (e.g., space, parking, meters, etc.) for the pre-dispatched provider devices 206a-206c. In the meanwhile, the flex forecasting pre-dispatch system 105 and/or the dynamic transportation matching system 104 can match other provider devices in the provider device queue 208 with requestor devices in the requestor device queue 214 for transport from the geographic area 210. After matching, provider devices from the provider device queue 208 can pick up and transport requestor devices from the requestor device queue 214 from the geographic area 210 (e.g., as illustrated with the provider devices 216a-216c associated with one or more requestor devices in transport).

Although FIG. 2 illustrates provider devices as a certain type of transportation vehicle, other types of transportation vehicles are herein contemplated (e.g., an airplane, bicycle, motorcycle, scooter, or other vehicle). Further, and as defined above, a provider device may refer to a computing device associated with, but independent of, a given transportation vehicle (e.g., a handheld smart phone operated by human operators). Similarly, FIG. 2 illustrates only a single requestor per provider device during transport after matching (as shown in relation to provider devices 216a-216c). However, in some embodiments, particularly for shared-ride modes, multiple requestor devices may be associated with a single provider device during transport, for example, based on a transportation request from one or more of the requestor devices in the requestor device queue 214 comprising a shared-ride request. These and other embodiments are herein contemplated, but are omitted for purposes of illustration and clarity.

As mentioned above, the flex forecasting pre-dispatch system 105 can utilize a pre-dispatch model to dynamically position candidate provider devices at a geographic area corresponding to requestor devices. For instance, before receiving a transportation request from a requestor device, the flex forecasting pre-dispatch system 105 can use a pre-dispatch model to intelligently dispatch a candidate provider device to the geographic area. FIGS. 3A-3D illustrate schematic diagrams for determining whether to pre-dispatch a candidate provider device to a geographic area in accordance with one or more embodiments. In particular, FIG. 3A illustrates the flex forecasting pre-dispatch system 105 utilizing a requestor device forecasting model 302 to determine a projected requestor device queue 326 in accordance with one or more embodiments. Specifically, for consideration of pre-dispatching a candidate provider device 306i to a geographic area 310, the requestor device forecasting model 302 utilizes a variety of input data. Based on this input data, including various conditions at time=t, the requestor device forecasting model 302 can generate the projected requestor device queue 326. The projected requestor device queue 326 at the geographic area 310 corresponds to time=t+ETAᵢ (i.e., time=t+ETA 308i) when the flex forecasting pre-dispatch system 105 estimates the candidate provider device 306i to arrive at the geographic area 310. For consideration of pre-dispatching other candidate provider devices, such as candidate provider devices 306j or 306k, the requestor device forecasting model 302 can correspondingly determine projected requestor device queues for ETAs 308j or 308k, and so forth.

To determine the conditions at time=t, the requestor device forecasting model 302 (and/or more generally, the flex forecasting pre-dispatch system 105) can determine a current requestor device queue 318, a current provider device queue 312, and an in-transit provider device queue 313. Each is discussed in turn. To determine the current requestor device queue 318, the requestor device forecasting model 302 can perform a count function to establish a current number of outstanding transportation requests (and corresponding requestor devices) received at the dynamic transportation matching system 104.

To determine the current provider device queue 312 and the in-transit provider device queue 313, the requestor device forecasting model 302 can obtain location data for the provider devices 314a-314h. Based on the location data for the provider devices 314a-314f indicating a same location as the geographic area 310, the requestor device forecasting model 302 can determine that the provider devices 314a-314f comprise the current provider device queue 312 of six provider devices. Similarly, based on the location data for the provider devices 314g-314h indicating a location beyond the geographic area 310, the requestor device forecasting model 302 can determine that the provider devices 314g-314h comprise the in-transit provider device queue 313 of two provider devices.

Other methods for determining the current provider device queue 312 and the in-transit provider device queue 313 are herein contemplated. For example, in some embodiments, the flex forecasting pre-dispatch system 105 may receive respective communications from the provider devices 314a-314f indicating arrival at the geographic area 310. Until receiving such an arrival communication, the flex forecasting pre-dispatch system 105 can ascertain that such pre-dispatched provider devices are still in-transit to the geographic area 310. In these or other embodiments, the arrival communication may be an automatic communication. For example, when a provider device location matches the geographic area 310, the provider device may transmit an arrival communication to the flex forecasting pre-dispatch system 105 (e.g., via a dynamic transportation matching application on the provider device).

In addition to the specific conditions just described for time=t, the requestor device forecasting model 302 can generate the projected requestor device queue 326 by analyzing features (e.g., input data) specific to the geographic area 310. As shown in FIG. 3A, features utilized to determine projected requestor devices can include historical transportation request data 320, temporal feature data 322, and/or third-party data 324.

In some embodiments, the historical transportation request data 320 comprises recent transportation request data for the geographic area 310. Such recent transportation request data can capture the rate at which requestor devices 316 are and have been entering the current requestor device queue 318 (e.g., an average transportation request rate). For example, the historical transportation request data 320 can include a number of transportation requests in the past twenty minutes, in five minute (non-overlapping) bins (e.g., recent transportation requests in the past zero to five minutes, five minutes to ten minutes, ten minutes to fifteen minutes, and fifteen minutes to twenty minutes). Additional or alternative embodiments include different time bins, whether overlapping or non-overlapping (e.g., thirty-second bins, two-minute bins, three-minute bins, seven-minute bins, fifteen-minute bins, and so forth). Further, in some embodiments, the historical transportation request data 320 comprises an average number of transportation requests over a larger period of time. For example, in some embodiments, the historical transportation request data 320 comprises an average number of transportation requests for the past several hours, days, weeks, and/or months in configurable time bins (e.g., a ten-minute time bin), whether overlapping or non-overlapping.

With respect to the temporal feature data 322, the requestor device forecasting model 302 utilizes the temporal feature data 322 to determine which portions of the historical transportation request data 320 and the third-party data 324 to apply in determining the projected requestor device queue 326 at time=t+ETAᵢ. For example, a first temporal feature may include a week number that indicates a number of the week in the year (0 to 51), a second temporal feature may include a day of the week, a third temporal feature may include an hour of the day, and a fourth temporal feature may include a minute of the hour. Additional or alternative temporal features and/or representations of the temporal feature data 322 are herein contemplated. For example, in some embodiments, the requestor device forecasting model 302 utilizes a circular transformation of the hour of the day (e.g., as (x,y) coordinates on a circle). In so doing, the requestor device forecasting model 302 can more precisely capture and/or represent temporal feature data 322 in comparison to a linear representation of time. For instance, a circular transformation of the hour of the day can reflect 11 pm on the 31st day of the month as being temporally close in time to 1 am on the 1st day of the following month. Thus, in some embodiments, the requestor device forecasting model 302 can utilize a polar coordinate system where the angle theta can represent the clock time (e.g., 8:00 am) or day (March 23rd), and the radius can represent one or more portions of the historical transportation request data 320. In so doing, requestor device forecasting model 302 can represent the historical transportation request data 320 at the angle theta of zero degrees for 00:00 hours (i.e., 12:00 am) as similar to the angle theta approaching three-hundred-sixty degrees at 23:55 hours (i.e., 11:55 pm just five minutes prior).

Based on one or more of the foregoing temporal features of the temporal feature data 322, the requestor device forecasting model 302 can, for example, identify t for the time=t and, in turn, select the appropriate time bins of the historical transportation request data 320 using t as the reference point (e.g., a zero-minute mark). Similarly, using the identified t for the time=t, the requestor device forecasting model 302 can obtain the appropriate portions of the third-party data 324 (e.g., the airplane flight arrival data for planes arriving in the next two minutes, five minutes, ten minutes, and so forth relative to time=t). In these or other embodiments, the temporal feature data 322 may further include time-correlated data, such as, for instance, cancellation rates, primetime rates, a number of online provider devices, or other transportation metrics that can affect the projected requestor device queue 326. In another example, the requestor device forecasting model 302 utilizes time-correlated data that relates to transportation requests based on holidays, local events (e.g., religious gatherings, cultural festivities, conventions, etc.), and so forth.

With respect to the third-party data 324, the requestor device forecasting model 302 can communicate with one or more third-party servers (e.g., the third-party server 116 described above in relation to FIG. 1) to obtain the third-party data 324. Based on the third-party data 324, the requestor device forecasting model 302 can more accurately predict the projected requestor device queue 326 at the geographic area 310. For example, in some embodiments, the third-party data 324 comprises maps data for determining location data and/or ETA data of provider devices. In these or other embodiments, to obtain this third-party data 324, the flex forecasting pre-dispatch system 105 can execute one or more application programming interface (API) calls to receive and/or request the third-party data 324 from a third-party server. For instance, the flex forecasting pre-dispatch system 105 can execute an API call to request ETA data from a third-party server for one or more provider devices and/or candidate provider devices. In some implementations, the flex forecasting pre-dispatch system 105 can execute an API call to request ETA data from a third-party server every few seconds. In response, the third-party server can provide ETA data based on the third-party server pinging a location of the provider device and determining a route between the pinged location and the geographic area 310. Thus, utilizing this particular third-party data 324 comprising ETAs of candidate provider devices, the requestor device forecasting model 302 can predict the projected requestor device queue 326 at the geographic area 310.

Additionally or alternatively, in some embodiments, where the geographic area 310 is an airport (or airport curb), examples of the third-party data 324 may include flight schedules and/or real-time flight information (e.g., flight number, delay estimation, departure city, landing time, deboarding time, gate number, terminal, baggage carousel, etc.). In other embodiments, where the geographic area 310 is a venue type location, for example, a convention center hosting a business convention, the third-party data 324 may include itinerary information of the business convention, break schedules, lunch sessions, or other information to help the requestor device forecasting model 302 more accurately predict the projected requestor device queue 326. As additional examples of the third-party data 324 with respect to sports venues, the third-party data 324 can include start times, half time, score updates, estimated end times, overtime alerts, inclement weather notices, etc. In other embodiments, where the geographic area 310 is a train station, bus station or other transit station, the third-party data 324 may include arrival times, departure times, destination locations, departure locations, route information, a stop schedule, and the like. In this manner, the third-party data 324 can comprise a wide variety of information and data sources beyond that of the dynamic transportation matching system 104 or server(s) 102 as also discussed above in relation to FIG. 1.

Based on the foregoing input data, including one or more of the conditions at time=t (e.g., the current requestor device queue 318, the current provider device queue 312, or the in-transit provider device queue 313), the historical transportation request data 320, the temporal feature data 322, or the third-party data 324, the requestor device forecasting model 302 can generate the projected requestor device queue 326. To do so, the requestor device forecasting model 302 may utilize a variety of methods. For example, in some implementations, the requestor device forecasting model 302 can utilize an average rate at which requestor devices 316 enter the current requestor device queue 318 (or in other terms, an average transportation request rate). In this embodiment, the requestor device forecasting model 302 estimates the projected requestor device queue 326 by multiplying the average transportation request rate by a time duration for some future interval of time (e.g., (t, t+ETAᵢ)). Thus, to determine the projected requestor device queue 326 at time=t+ETAᵢ for the candidate provider device 306i, the requestor device forecasting model 302 can multiply an average transportation request rate by a time duration in the amount of ETA 308i. The foregoing can be represented as the following example expression:

F(t+ETA(t))=μ̅_{t,t+ETA(t)}*ETA(t),

where the term F(t+ETA(t)) represents the projected requestor device queue 326, the term μ̅_{t,t+ETA(t)} represents an average transportation request rate projected for the time interval (t, t+ETAᵢ), and the term ETA(t) represents the ETA 308i. In these or other embodiments, the average transportation request rate projected for the time interval (t, t+ETAᵢ) can be estimated as follows:

$${\overline{μ}}_{t , t + E T A ( t )} = \frac{1}{E T A ( t )} {\int }_{t}^{t + E T A ( t )} μ ( s ) ds ,$$

where μ̅(s) represents a transportation request rate for a given time, and the term ∫ₜ^{t+ETA(t)} μ(s) ds represents the integral function for μt(s) with respect to time over the time interval (t, t+ETAᵢ).

In another example implementation, the requestor device forecasting model 302 can utilize the above-discussed input data to generate a lookup table comprising various portions of the historical transportation request data 320. Then, using the lookup table, the requestor device forecasting model 302 can determine the projected requestor device queue 326. For example, the requestor device forecasting model 302 can extrapolate a number of requestor devices based on the lookup table. Additionally or alternatively, the requestor device forecasting model 302 may predict a number of requestor devices for the projected requestor device queue 326 based on transportation request data in the lookup table corresponding to a same date and time of the previous year, week, etc.

In yet another example implementation, the requestor device forecasting model 302 can utilize the above-discussed input data in accordance with an exponential smoothing model to generate the projected requestor device queue 326. For example, given a look-back window of time L, the requestor device forecasting model 302 can determine, at certain time intervals during the look-back window of time L, a corresponding pairing rate μᵢ at which provider devices in the current provider device queue 312 pair with requestor devices in the current requestor device queue 318 for pickup and transport. In turn, the requestor device forecasting model 302 can generate a listing of pairing rates (e.g., [μt₀, μt₁, μt₂, . . . , μₙ]) corresponding to the time intervals for applying to an exponential smoothing model. In some embodiments, the exponential smoothing model is represented according to the following example expressions:

$$\{ \begin{matrix}{s}_{0} = {μ}_{0} \\ {s}_{i} = α {μ}_{i} + ( 1 - α ) {s}_{i - 1}\end{matrix} , i \geq 1$$

where αϵ(0,1) is the smoothing factor. In these or other embodiments utilizing an exponential smoothing model, the requestor device forecasting model 302 can tune one or more hyperparameters, such as the look-back window L, Δt for smaller/larger time intervals, and α for an improved smoothing factor. Additionally or alternatively, in some embodiments, the requestor device forecasting model 302 can obtain or otherwise learn various parameters such as, for example, an average time it takes for a requestor to get into a transportation vehicle, an average delay between a requestor device 316 submitting a transportation request and the requestor device 316 physically arriving at the curb, etc.

Additionally or alternatively, in some embodiments, the requestor device forecasting model 302 utilizes the above-discussed input data in accordance with a double exponential smoothing model to generate the projected requestor device queue 326. To do so, the requestor device forecasting model 302 can perform acts and algorithms according to a double exponential smoothing model, a Poisson regression model, an autoregressive integrated moving average (ARIMA) model, a seasonal autoregressive integrated moving average (SARIMA) model, or a non-linear model such as LightGBM.

The requestor device forecasting model 302 can also utilize a variety of additional machine-learning models to generate the projected requestor device queue 326. For example, the requestor device forecasting model 302 can include a variety of neural networks, such as a recurrent neural network (RNN) (e.g., a long short-term memory (LSTM) neural network). To train a neural network to generate the projected requestor device queue 326, the flex forecasting pre-dispatch system 105 can compare a predicted projected requestor device queue with ground truth data (e.g., observed data) to determine a loss using a loss function. In these or other embodiments, the loss function can include, but is not limited to, a regression loss function (e.g., a mean square error function, a quadratic loss function, an L2 loss function, a mean absolute error/L1 loss function, mean bias error). Additionally, or alternatively, the loss function can include a classification loss function (e.g., a hinge loss/multi-class SVM loss function, cross entropy loss/negative log likelihood function). Further, the loss function can return quantifiable data (e.g., probability values, confidence scores, etc.) regarding the difference between the predicted projected requestor device queue and ground truth data. Based on this determined loss, the flex forecasting pre-dispatch system 105 can adjust various parameters/hyperparameters to improve the quality/accuracy of a predicted projected requestor device queue in subsequent training iterations—by narrowing the difference (e.g., increasing a probability value) between the predicted projected requestor device queue and ground truth data.

In these or other embodiments of the requestor device forecasting model 302, the requestor device forecasting model 302 can, in conjunction with the projected requestor device queue 326, determine a confidence score indicating a probability that the projected requestor device queue 326 will accurately reflect conditions at the time corresponding to time=t+ETAᵢ. For example, many of the machine learning models discussed above generate a prediction and corresponding confidence level. The flex forecasting pre-dispatch system 105 can utilize this confidence level as a confidence score. The flex forecasting pre-dispatch system 105 can utilize a variety of other confidence scores as well. For example, in some embodiments, the requestor device forecasting model 302 compares previous (e.g., recent) projected requestor device queues with the actual requestor device queues observed (e.g., like a ground truth requestor device queue). Such a comparison may indicate a running average error value or other metric that the requestor device forecasting model 302 can use to quantify a confidence score with respect to the projected requestor device queue 326.

With the projected requestor device queue 326 determined, in some embodiments, the requestor device forecasting model 302 can scale this value for other time intervals. For example, by multiplying the projected requestor device queue 326 by the quotient of a scaled interval of time divided by the time interval (t, t+ETAᵢ), the requestor device forecasting model 302 can determine a scaled projected requestor device queue. The foregoing can be represented according to the following example expression,

$$F ( x ) = \hat{F} * \frac{x}{( t , t + E T {A}_{i} )} ,$$

where the term F(x) represents a scaled projected requestor device queue for a time interval of x duration, the term \hat{F} represents the projected requestor device queue 326 for the time interval (t, t+ETAᵢ), and the term x represents a duration of a scaled time interval. Thus, in some embodiments, the requestor device forecasting model 302 can reduce computational resources and/or increase an efficiency for the flex forecasting pre-dispatch system 105. For instance, by generating a scaled projected requestor device queue for other candidate provider devices with similar ETAs, the requestor device forecasting model 302 can bypass one or more model execution runs otherwise employed in a same or similar manner as discussed in the foregoing paragraphs.

Additionally or alternatively to the foregoing, in some embodiments, the requestor device forecasting model 302 may determine multiple projected requestor device queues (e.g., a batch of projected requestor device queues). In these or other embodiments, the requestor device forecasting model 302 may perform such batch predictions of the projected requestor device queues at predetermined time increments (e.g., every five minutes).

As just described in relation to FIG. 3A, the flex forecasting pre-dispatch system 105 utilizes the requestor device forecasting model 302 to determine the projected requestor device queue 326. Based on the projected requestor device queue 326, the flex forecasting pre-dispatch system 105 can then determine a projected provider device queue. FIG. 3B illustrates the flex forecasting pre-dispatch system 105 utilizing the projected requestor device queue 326 to determine a projected provider device queue 328 in accordance with one or more embodiments of the present disclosure. Specifically, for consideration of pre-dispatching the candidate provider device 306i to the geographic area 310, the flex forecasting pre-dispatch system 105 utilizes a variety of input data to determine the projected provider device queue 328. The projected provider device queue 328 at the geographic area 310 corresponds to time=t+ETAᵢ (i.e., time=t+ETA 308i) when the flex forecasting pre-dispatch system 105 estimates the candidate provider device 306i to arrive at the geographic area 310. In so doing, the flex forecasting pre-dispatch system 105 can check that, in pre-dispatching the candidate provider device 306i, the projected provider device queue 328 will have sufficient availability for the candidate provider device 306i upon arrival at the geographic area 310. This process is described more below in relation to FIGS. 3C-3D. Additionally, for consideration of pre-dispatching other candidate provider devices, such as candidate provider devices 306j or 306k, the flex forecasting pre-dispatch system 105 can correspondingly determine projected provider device queues for ETAs 308j or 308k, and so forth.

As shown in FIG. 3B, the flex forecasting pre-dispatch system 105 determines the projected provider device queue 328 based on various conditions at time=t and the projected requestor device queue 326. In some embodiments, the flex forecasting pre-dispatch system 105 determines the projected provider device queue 328 based on one or more of the current provider device queue 312, the in-transit provider device queue 313, the current requestor device queue 318, or the projected requestor device queue 326. As an example, the flex forecasting pre-dispatch system 105 can determine the projected provider device queue 328 by comparing provider device queues and requestor device queues. For instance, the flex forecasting pre-dispatch system 105 can determine the projected provider device queue 328 by (i) adding the current provider device queue 312 and the in-transit provider device queue 313, (ii) adding the current requestor device queue 318 and the projected requestor device queue 326, and (iii) taking the difference between (i) and (ii). This particular embodiment can be represented according to the following example expression:

Q_{c}(t+ETA(t))=Q_{c}(t)+Q_{pd}(t)−Qᵣ(t)−F(ETA(t)),

where the term Q_{c}(t+ETA(t)) represents the projected provider device queue 328, the term Q_{c}(t) represents the current provider device queue 312, the term Q_{pd} (t) represents the in-transit provider device queue 313, the term Qᵣ(t) represents the current requestor device queue 318, and the term F(ETA(t)) represents the projected requestor device queue 326.

The flex forecasting pre-dispatch system 105 can determine the projected provider device queue 328 utilizing alternative approaches. For example, in one implementation, the flex forecasting pre-dispatch system 105 can determine the projected provider device queue 328 by first determining an estimated number of future pairings of provider devices and requestor devices in the time interval (t, t+ETA 308i). To determine the estimated number of future pairings, the flex forecasting pre-dispatch system 105 can (i) add the current provider device queue 312 and the in-transit provider device queue 313, (ii) add the current requestor device queue 318 and the projected requestor device queue 326, and (iii) compare (i) and (ii) to find the lesser of (i) and (ii). The lesser of (i) and (ii) represents the estimated number of future pairings for the time interval (t, t+ETA 308i). With respect to FIG. 3B, the estimated number of future pairings comprises two pairings, specifically the provider devices 314a-314b projected to have left the provider device queue to transport respective requestor devices. In other terms, the estimated number of future pairings can be represented according to the following example expression:

D(t,t+ETA(t))=min(Qᵥ(t),Qᵣ(t)+F(t,t+ETA)),

where the term D (t+ETA(t)) represents the estimated number of future pairings for the time interval (t, t+ETA 308i), the term Qᵥ(t) represents the combination of the current provider device queue 312 and the in-transit provider device queue 313, the term Qᵣ(t) represents the current requestor device queue 318, the term F(t+ETA(t)) represents the projected requestor device queue 326, and min ( ) represents a minimum function that returns the smallest input value.

Then, utilizing the estimated number of future pairings, the flex forecasting pre-dispatch system 105 can determine the projected provider device queue 328 by taking the difference between the estimated number of future pairings and a sum of the current provider device queue 312 and the in-transit provider device queue 313. This particular embodiment for determining the projected provider device queue 328 can be represented according to the following example expression:

Q(t+ETA(t))=Qᵥ(t)−min(Qᵥ(t),Qᵣ(t)+F(t,t+ETA(t))),

where the term Qᵥ(t) represents the combination of the current provider device queue 312 and the in-transit provider device queue 313, and the term min (Qᵥ(t),Qᵣ(t)+F(t+ETA(t))) represents the estimated number of future pairings.

Based on determining the projected provider device queue 328, the flex forecasting pre-dispatch system 105 can predict that the projected provider device queue 328 will comprise the provider devices 314c-314h at time=t+ETAᵢ if the candidate provider device 306i is pre-dispatched at time=t. In some embodiments, the flex forecasting pre-dispatch system 105 may further predict a projected in-transit provider device queue 329 corresponding to time=t+ETAᵢ (e.g., by utilizing the same or similar methods as disclosed herein for consideration of pre-dispatching the candidate provider device 306i). For example, as shown in FIG. 3B, the projected in-transit provider device queue 329 comprises the candidate provider device 306j. However, as with any of the queues illustrated and described in the present disclosure, more or fewer devices can be included in the projected in-transit provider device queue 329.

Other variations of the foregoing methods, including additional or alternative inputs, for determining the projected provider device queue 328 are herein contemplated. For example, in some embodiments, the flex forecasting pre-dispatch system 105 distinguishes between candidate provider devices positioned at a designated staging lot associated with a staging lot ETA to the geographic area 310 and candidate provider devices positioned elsewhere with a variety of ETAs to the geographic area 310. Accordingly, in some embodiments for candidate provider devices positioned outside of a designated staging lot, the flex forecasting pre-dispatch system 105 determines the projected provider device queue 328 utilizing a modified in-transit provider device queue different than the in-transit provider device queue 313.

Specifically, for candidate provider devices positioned outside of a staging lot and which have an ETA less than a staging lot ETA, the flex forecasting pre-dispatch system 105 may determine a modified in-transit provider device queue by: (i) adding one provider device to the in-transit provider device queue 313, (ii) dividing the lessor ETA by the staging lot ETA, and (iii) taking the nearest integer (rounded down) for the scalar product of (i) and (ii). This particular embodiment for determining the modified in-transit provider device queue can be represented according to the following example expression:

if ETA_{outside lot}ⁱ<ETA_{staging lot}

then Q_{ahead}ⁱ=floor((Q_{pd}+1)·ETA_{outside lot}ⁱ/ETA_{staging lot})

else Q_{ahead}ⁱ=Q_{pd},

where the term ETA_{outside lot}ⁱ represents the ETA of the candidate provider device outside of the designated staging lot, the term ETA_{staging lot} represents the ETA associated with candidate provider devices in the designated staging lot, Q_{ahead}ⁱ head represents the modified in-transit provider device queue, the term Q_{pd} represents the in-transit provider device queue 313 of pre-dispatched candidate provider devices at time=t, and the term floor( ) represents a floor function that takes as input a real number and returns the greatest integer less than or equal to the input value.

Moreover, by determining a modified in-transit provider device queue as just described, the flex forecasting pre-dispatch system 105 can utilize a uniform distribution of pre-dispatched candidate provider devices between the designated staging lot and the geographic area 310. In so doing, the flex forecasting pre-dispatch system 105 can reduce computational resources by avoiding real-time tracking of ETAs of pre-dispatched candidate provider devices.

Additionally or alternatively, in some embodiments, the flex forecasting pre-dispatch system 105 can determine a modified in-transit provider device queue for each candidate provider device according to their respective ETAs (sorted from low to high or another suitable manner). In these or other embodiments, the flex forecasting pre-dispatch system 105 may generate a listing of candidate provider devices and pre-dispatched provider devices, each associated with their respective ETAs. Further, in some embodiments, the flex forecasting pre-dispatch system 105 updates the listing every few seconds with updated ETAs. In this manner, the flex forecasting pre-dispatch system 105 can utilize more accurate ETA data for a more accurate prediction of the projected provider device queue 328.

As just described in relation to FIG. 3B, the flex forecasting pre-dispatch system 105 utilizes various conditions at time=t and the projected requestor device queue 326 to determine the projected provider device queue 328. Based on the projected provider device queue 328, the flex forecasting pre-dispatch system 105 can then compare the projected provider device queue 328 with a queue capacity for determining whether to consider pre-dispatching a candidate provider device (in this case, the candidate provider device 306i) to the geographic area 310. FIG. 3C illustrates the flex forecasting pre-dispatch system 105 utilizing a look-ahead model 330 to compare the projected provider device queue 328 to a queue capacity in accordance with one or more embodiments of the present disclosure.

By utilizing the look-ahead model 330, the flex forecasting pre-dispatch system 105 can determine that, in pre-dispatching the candidate provider device 306i, the projected provider device queue 328 will have sufficient availability (e.g., space, parking, meters, etc.) for the candidate provider device 306i upon arrival at the geographic area 310. By additionally utilizing a look-behind model 332, the flex forecasting pre-dispatch system 105 can determine that, in pre-dispatching the candidate provider device 306i, a projected provider device queue will have sufficient availability for an earlier pre-dispatched candidate provider device upon arrival at the geographic area 310. Thus, if the look-ahead model 330 and the look-behind model 332 both indicate compatibility with a queue capacity, the flex forecasting pre-dispatch system 105 can pre-dispatch the candidate provider device 306i to the geographic area 310. FIG. 3C illustrates application of the look-ahead model 330 in accordance with one or more embodiments. Application of the look-behind model 332 in accordance with one or more embodiments is described below in relation to FIG. 3D.

In relation to FIG. 3C, the flex forecasting pre-dispatch system 105 utilizes the look-ahead model 330 to perform a queue capacity comparison 334 corresponding to time=t+ETAᵢ when the flex forecasting pre-dispatch system 105 estimates that the candidate provider device 306i will arrive at the geographic area 310. In particular, the look-ahead model 330 can, at the queue capacity comparison 334, compare the projected provider device queue 328 with a queue capacity, such as a curb capacity or other suitable queue threshold. As an example, if the projected provider device queue 328 is less than a queue capacity comprising a maximum curb capacity, the look-ahead model 330 may indicate in a decision 336 that the projected provider device queue 328 is less than the queue capacity. By comporting with the queue capacity according to the look-ahead model 330, the candidate provider device 306i qualifies for pre-dispatch consideration.

On the other hand, if the projected provider device queue 328 is greater than (or equal to) a queue capacity comprising the maximum curb capacity, the look-ahead model 330 may indicate in a decision 338 that the projected provider device queue 328 fails to comport with the queue capacity. By failing to comport the queue capacity according to the look-ahead model 330, the candidate provider device 306i fails to qualify for pre-dispatch consideration (at least temporarily). In turn, the flex forecasting pre-dispatch system 105 can withhold from pre-dispatching the candidate provider device 306i.

In some embodiments, the flex forecasting pre-dispatch system 105 utilizes the look-ahead model 330 to iteratively perform the queue capacity comparison 334, for example, every ten seconds. Thus, if the look-ahead model 330 initially returns the decision 338, the look-ahead model 330 may iteratively re-execute the queue capacity comparison 334 with updated information corresponding to time=t_{update} for one or more of the current requestor device queue, the current provider device queue, the in-transit provider device queue, the historical transportation request data 320, the temporal feature data 322, or the third-party data 324. Further, the look-ahead model 330 may iteratively re-execute the queue capacity comparison 334 with updated information corresponding to time=t_{update} ETA_{update} for one or more of the the projected requestor device queue, the projected provider device queue, or the projected in-transit provider device queue.

In some embodiments, the look-ahead model 330 iteratively re-executes the queue capacity comparison 334 until an updated projected provider device queue is less than the queue capacity and the look-ahead model 330 returns the decision 336. In other embodiments, the look-ahead model 330 iteratively re-executes the queue capacity comparison 334 and returns the decision 338 only for a threshold number of times or for a threshold duration, at which point the flex forecasting pre-dispatch system 105 may take the candidate provider device 306i offline, suggest a different driving time/geographic area, navigate the candidate provider device 306i to a different geographic area, etc.

Additional or alternative queue capacities are herein contemplated. For example, in some embodiments, the look-ahead model 330 performs the queue capacity comparison 334 by utilizing a queue threshold comprising a pre-dispatch cap value indicating a maximum number of provider devices allowed to be in pre-dispatch mode (or in-transit) to the geographic area 310 at a given time. In this particular embodiment, the look-ahead model 330 can compare the queue threshold of a pre-dispatch cap value with a modified in-transit provider device queue (e.g., for candidate provider devices outside of a designated staging lot as described above). If the modified in-transit provider device queue is less than the queue threshold of a pre-dispatch cap value, the flex forecasting pre-dispatch system 105 may consider a given candidate provider device for pre-dispatch.

Additionally or alternatively, the flex forecasting pre-dispatch system 105 can also apply a confidence threshold in conjunction with a queue capacity. For example, in some embodiments, the flex forecasting pre-dispatch system 105 can determine a confidence score associated with a projected provider device queue in a same or similar manner as the requestor device forecasting model 302 can perform with respect to projected requestor device queues. Accordingly, if a projected provider device queue associated with a given confidence score fails to comport with the threshold confidence score (e.g., ninety percent), the flex forecasting pre-dispatch system 105 may return the decision 338 and withhold pre-dispatch. Thus, the flex forecasting pre-dispatch system 105 can require that the candidate provider device comport with the queue capacity (e.g., less than a maximum number of provider devices in the queue) as well as the confidence threshold (e.g., at a 90 percent confidence level).

Further, in some embodiments, the flex forecasting pre-dispatch system 105 can update one or more listings of candidate provider devices or pre-dispatched provider devices, each with their respective ETAs to the geographic area 310. For example, based on updated ETA information (e.g., at ten second intervals), the flex forecasting pre-dispatch system 105 can improve an accuracy and effectiveness of pre-dispatching determinations. To do so, in some embodiments, the flex forecasting pre-dispatch system 105 generates a listing of candidate provider devices. In some implementations, the listing of candidate provider devices correspond to candidate provider devices positioned outside of a designated staging lot associated with a staging lot ETA to the geographic area 310.

In such a listing of candidate provider devices, the flex forecasting pre-dispatch system 105 can sort candidate provider devices according to their ETAs to the geographic area 310. For each candidate provider device in the listing of candidate provider devices (e.g., starting from the lowest ETA to the geographic area), the flex forecasting pre-dispatch system 105 can determine a corresponding projected provider device queue. For instance, in a same or similar manner as described above, the flex forecasting pre-dispatch system 105 can determine a projected provider device queue based on an in-transit provider device queue, a current provider device queue, etc.

If, for a given candidate provider device, the projected provider device queue is less than a queue capacity, then that given candidate provider device can qualify for possible pre-dispatch. In turn, for each candidate provider device behind the given candidate provider device, the flex forecasting pre-dispatch system 105 can determine whether adding one provider device to a projected provider device queue is compatible with a queue capacity. If the queue capacity is compatible, the flex forecasting pre-dispatch system 105 can add the given candidate provider device to a list of candidate provider devices selected to be pre-dispatched, and once pre-dispatched, to a list of provider devices in the in-transit provider device queue. After updating these or other listings based on the foregoing, the flex forecasting pre-dispatch system 105 can iterate, thereby continually pre-dispatching candidate provider devices from the listing of candidate provider devices positioned outside of a designated staging lot. This particular embodiment can be represented according to the following example expressions:

for each provider device i in Lₒ, do:

compute Q_{ahead}ⁱ given ETAⁱ and Lₒ (1)

compute Q_{c}ⁱ(t+ETAⁱ) (2)

if Q_{c}ⁱ(t+ETAⁱ)<Cₘₐₓ,then go to next step, else break (3)

compute L_{behind}ⁱ given ETAⁱ and L_{pd} (4)

compute Q_{c}^{j}(t+ETA^{j})given ETA^{j} and Lₒ (5)

if Q_{c}ⁱ(t+ETA^{j})+1≤Cₘₐₓ for all j in L_{behind}ⁱ, then: (6)

add provider device i to L_{c} (6a)

add provider device i to L_{pd} (6b)

update L_{pd} (6c)

else: continue, (7)

where the term L₀ represents the listing of candidate provider devices positioned outside of a designated staging lot, the term Q_{ahead}ⁱ represents the number of pre-dispatched provider devices ahead of provider device i, the term Q_{c}ⁱ (t+ETAⁱ) represents the projected provider device queue for the provider device i, the term Cₘₐₓ represents the maximum curb capacity, the term L_{behind}ⁱ represents the listing of pre-dispatched provider devices in-transit to the geographic area that are behind the provider device i, the term L_{c} represents the listing of candidate provider devices selected to be pre-dispatched from Lₒ, and the term L_{pd} represents the listing of provider devices in-transit to the geographic area (ordered by ETAs).

Additionally or alternatively, in some embodiments, the flex forecasting pre-dispatch system 105 uses one or more of the foregoing listings of candidate provider devices in determining whether to pre-dispatch candidate provider devices from a designated staging lot associated with a staging lot ETA to the geographic area 310. For example, in some implementations the flex forecasting pre-dispatch system 105 may use a length of the L_{pd} listing of provider devices (e.g., len(L_{pd})) to represent the in-transit provider device queue 313 discussed above in determining one or more of the projected requestor device queue 326 and/or the projected provider device queue 328.

As mentioned, the flex forecasting pre-dispatch system 105 can (additionally or alternatively) utilize a look-behind model 332 in pre-dispatching candidate provider devices. For example, FIG. 3D illustrates the flex forecasting pre-dispatch system 105 utilizing the look-ahead model 330 and the look-behind model 332 to compare multiple projected provider device queues to a queue capacity in accordance with one or more embodiments of the present disclosure. In particular, FIG. 3D illustrates the flex forecasting pre-dispatch system 105 determining whether to pre-dispatch a specific candidate provider device 306n.

As discussed above in relation to FIG. 3C, the flex forecasting pre-dispatch system 105 utilizes the look-ahead model 330 at a queue capacity comparison 344. Through this approach, the flex forecasting pre-dispatch system 105 can determine that, in pre-dispatching the candidate provider device 306n, the projected provider device queue 342 will have sufficient availability (e.g., space, parking, meters, etc.) for the candidate provider device 306n upon arrival at the geographic area 310 at a time corresponding to tₓ+ETAₙ. Based on the look-ahead model 330 indicating that the projected provider device queue 342 is less than a queue capacity, the candidate provider device 306n qualifies for pre-dispatch consideration.

As shown in FIG. 3D, the flex forecasting pre-dispatch system 105 also utilizes the look-behind model 332. By utilizing the look-behind model 332, the flex forecasting pre-dispatch system 105 can determine whether, in pre-dispatching the candidate provider device 306n, a projected provider device queue will have sufficient availability for an earlier pre-dispatched candidate provider device (e.g., the candidate provider device 306i) upon arrival at the geographic area 310.

Specifically, as illustrated in FIG. 3D, the flex forecasting pre-dispatch system 105 predicts the arrival of the candidate provider device 306n (associated with ETAₙ) at the geographic area 310 as prior to the arrival of the candidate provider device 306i (i.e., ETA 308i) at the geographic area 310. Accordingly, the flex forecasting pre-dispatch system 105 utilizes the look-behind model 332 to determine whether there is sufficient availability in a projected provider device queue 340 for the candidate provider device 306i of an in-transit provider device queue 341. The projected provider device queue 340 corresponds to time=t+ETAᵢ (i.e., the estimated arrival time of the earlier pre-dispatched candidate provider device 306i).

With the addition of the candidate provider device 306n, the look-behind model 332 can figuratively look back to ensure the integrity of a previous system-decision to pre-dispatch the candidate provider device 306i. Accordingly, the projected provider device queue 340 under scrutiny for pre-dispatch consideration comprises provider devices 314c-314h and (as a test assumption) the candidate provider device 306n ahead of the candidate provider device 306i. In view of the projected provider device queue 340, the look-behind model 332 can perform at the queue capacity comparison 344 the same or similar acts and algorithms discussed above in relation to FIG. 3C.

As an example, if the projected provider device queue 340 is less than a queue capacity comprising a maximum curb capacity, the look-behind model 332 may indicate in a decision 346 that the projected provider device queue 340 is less than the queue capacity. By comporting with the queue capacity according to the look-behind model 332, the flex forecasting pre-dispatch system 105 can, in turn, pre-dispatch the candidate provider device 306n to the geographic area 310. On the other hand, if the projected provider device queue 340 is greater than (or equal to) a queue capacity comprising the maximum curb capacity, the look-behind model 332 may indicate in a decision 348 that the projected provider device queue 340 fails to comport with the queue capacity.

Indeed, as shown in FIG. 3D, the look-behind model 332 can predict that there will be insufficient availability in the projected provider device queue 340 for the candidate provider device 306i due to the addition of the candidate provider device 306n. By failing to comport with the queue capacity according to the look-behind model 332, the candidate provider device 306n therefore fails to qualify for pre-dispatch consideration, at least temporarily. In turn, the flex forecasting pre-dispatch system 105 can withhold from pre-dispatching the candidate provider device 306n. In a same or similar manner as just described, the look-behind model 332 in some embodiments may analyze all affected up-stream provider devices (i.e., all earlier pre-dispatched provider devices of the in-transit provider device queue 341, such as the candidate provider device 306j). In these or other embodiments however, the look-behind model 332 and the look-ahead model 330 are independent of each other. Accordingly, the flex forecasting pre-dispatch system 105 can execute the look-behind model 332 in addition to, or in the alternative to, the look-ahead model 330 (i.e., before, after, or without the look-ahead model 330).

Additionally or alternatively, the flex forecasting pre-dispatch system 105 may determine whether to pre-dispatch a candidate provider device based on other acts and algorithms associated with a different pre-dispatch model. In some embodiments for example, according to an additional or alternative pre-dispatch model, the flex forecasting pre-dispatch system 105 may pre-dispatch a number of candidate provider devices based on minimum or maximum thresholds. For instance, a minimum threshold can comprise a minimum number of provider devices that the flex forecasting pre-dispatch system 105 determines should be available at the geographic area 310 for matching with and picking up requestor devices. In effect, the flex forecasting pre-dispatch system 105 can set a minimum threshold of provider devices to be located at the geographic area 310 to dictate how aggressive the flex forecasting pre-dispatch system 105 is in matching with and picking up requestor devices. In another example, the flex forecasting pre-dispatch system 105 can determine a maximum threshold as corresponding to a maximum curb capacity or other suitable limit.

In specific implementations, the flex forecasting pre-dispatch system 105 can pre-dispatch a number of candidate provider devices by comparing a current requestor device queue with a maximum curb capacity. If the current requestor device queue is larger than the maximum curb capacity, the flex forecasting pre-dispatch system 105 can less aggressively pre-dispatch candidate provider devices. On the other hand, if the current requestor device queue is smaller than the maximum curb capacity (but greater than a minimum threshold of provider devices), the flex forecasting pre-dispatch system 105 can pre-dispatch a number of candidate provider devices less than or equal to the maximum curb capacity. Further, if the current requestor device queue is smaller than the maximum curb capacity (and also smaller than a minimum threshold of provider devices), the flex forecasting pre-dispatch system 105 can more aggressively pre-dispatch a number of candidate provider devices (above the minimum threshold of provider devices and below the maximum curb capacity). This particular embodiment can be represented according to the following example expression:

Q_{pd}(t)=max(Cₘᵢₙ,min(Cₘₐₓ,Qᵣ(t)))−Qᵥ(t),

where the term the term Q_{pd} (t) represents a number of candidate provider devices to pre-dispatch at time=t, the term Cₘₐₓ represents a first queue capacity comprising a maximum curb capacity, the term Cₘᵢₙ represents a second queue capacity comprising a minimum number of provider devices desired at the geographic area, the term Qᵣ(t) represents a current requestor device queue, the term Qᵥ(t) represents the combination of a current provider device queue and an in-transit provider device queue, min ( ) represents a minimum function that returns the smallest input value, and max ( ) represents a maximum function that returns the greatest input value.

As mentioned above, the flex forecasting pre-dispatch system 105 can select which pre-dispatch model (e.g., a better-performing pre-dispatch model) to implement. FIG. 4 illustrates the flex forecasting pre-dispatch system 105 comparing simulated performance metrics to select a pre-dispatch model in accordance with one or more embodiments of the present disclosure.

As shown in FIG. 4, the flex forecasting pre-dispatch system 105 can execute a first simulation 404 of a first pre-dispatch model 402 to generate a first set of simulated performance metrics 406. Likewise shown, the flex forecasting pre-dispatch system 105 can execute a second simulation 410 of a second pre-dispatch model 408 to generate a second set of simulated performance metrics 412. In these or other embodiments, the first simulation 404 and the second simulation 410 can be based on a same set of test data, quality standards, historical data, geographic-area specific data, etc. In particular, the first simulation 404 and the second simulation 410 virtually simulate respective outcomes based on the test data and the respective model architectures and features for the first pre-dispatch model 402 and the second pre-dispatch model 408.

For example, in some embodiments, at least one of the first pre-dispatch model 402 or the second pre-dispatch model 408 comprises the requestor device forecasting model 302 described above in relation to FIG. 3A. Additionally or alternatively, the first pre-dispatch model 402 and the second pre-dispatch model 408 comprise various different parameters, for example, queue capacities, forecasting intervals, ETA call intervals, a minimum number of pre-dispatched candidate provider devices, forecasting (or no forecasting), etc.

Further, the flex forecasting pre-dispatch system 105 can optimize these or other parameters for at least one of the first pre-dispatch model 402 or the second pre-dispatch model 408. For example, based on a comparison 414 of the first set of simulated performance metrics 406 and the second set of simulated performance metrics 412, the flex forecasting pre-dispatch system 105 can return a decision 416 indicating a selection of the better-performing pre-dispatch model. In turn, the flex forecasting pre-dispatch system 105 can implement the selected pre-dispatch model, for example, by selecting a queue capacity based on the comparison 414 of the first set of simulated performance metrics 406 and the second set of simulated performance metrics 412. That is, the flex forecasting pre-dispatch system 105 can implement the selected pre-dispatch model and observe real-world results from implementing the selected pre-dispatch model. Based on such observation and resultant learning, the flex forecasting pre-dispatch system 105 can iteratively select additional parameters to tweak, simulate, compare, implement, and learn.

In some implementations, based on executing one or both of the first pre-dispatch model 402 or the second pre-dispatch model 408, the flex forecasting pre-dispatch system can generate respective simulated performance metrics 406, 412 such as average requestor wait time, size (or number) of the requestor device queue over a period of time, average number of transportation requests per flight arrival, conversion metrics (for provider devices and/or requestor devices), throughput metrics (e.g., pickups/minute), inference metrics (e.g., relating to other on-demand provider devices), congestion metrics, etc. Additionally or alternatively, other simulated performance metrics 406, 412 may comprise a bookings metric, a cancellation request metric (for provider devices and/or requestor devices), an upfront fare amount for the transportation, a matching efficiency, a provider payout amount, an ETA of the provider device at a pickup location of the requestor, an amount of time between the provider device accepting the transportation request and the requestor device cancelling the transportation request, and/or a distance between the requestor device and the pickup location.

Additionally or alternatively, other simulated performance metrics 406, 412 may comprise an actual arrival time deviation from the ETA, a number of communications (e.g., voice calls, texts, etc.) between the requestor device and the provider device, a change in provider device ETA since acceptance of the transportation request or a pre-dispatch request, a number of additional transportations/requestors assigned to the transportation route since acceptance of the transportation request, a number of transportations or requestors assigned to the transportation route prior to acceptance of the transportation request, an amount of requestor movement since submission of the transportation request, an amount of time between submission of the transportation request and acceptance of the transportation request, elapsed time since acceptance of the transportation request, a number of finished/converted transportations, a re-submission rate of transportation requests for the requestor (e.g., a historical re-submission rate), a number of cancelled transportation requests for a particular requestor, a requestor distance from pickup location at time of request, etc.

Additionally or alternatively, other simulated performance metrics 406, 412 may comprise, for example, an amount of time, a projected monetary value (e.g., monetary cost or profit margin), a provider device efficiency in terms of time or cost, or a computational efficiency (e.g., a measurement of MHz or GHz over time and/or a system bandwidth consumption in megabytes, gigabytes, terabytes, petabytes, etc.). Additionally or alternatively, simulated performance metrics 406, 412 may include a configurable value or measurement of requestor satisfaction, revenue, loyalty, etc. over a period of time for on-demand transportation.

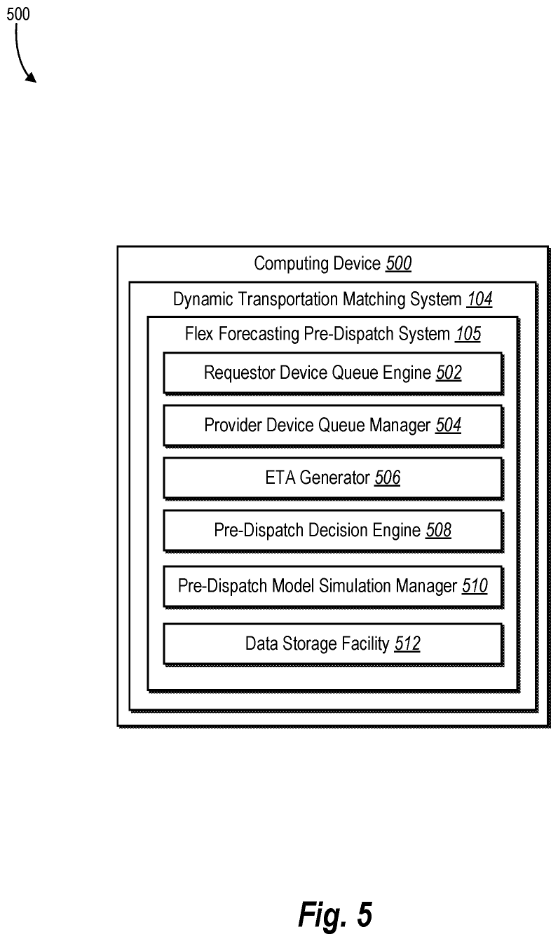

Turning to FIG. 5, additional detail will now be provided regarding various components and capabilities of the flex forecasting pre-dispatch system 105. In particular, FIG. 5 illustrates an example schematic diagram of the flex forecasting pre-dispatch system 105 implemented by a computing device 500 (e.g., the server(s) 102, the provider device 106a, and/or the requestor device 110a) in accordance with one or more embodiments of the present disclosure. As shown, the computing device 500 can implement the flex forecasting pre-dispatch system 105 and/or the dynamic transportation matching system 104. Also illustrated, the flex forecasting pre-dispatch system 105 can include a requestor device queue engine 502, a provider device queue manager 504, an ETA generator 506, a dispatch decision engine 508, a pre-dispatch model simulation manager 510, and a data storage facility 512.

The requestor device queue engine 502 can obtain, send, receive, process, analyze and/or forecast data corresponding to requestor devices and associated transportation requests as described in relation to the foregoing figures. For example, the requestor device queue engine 502 can determine a current requestor device queue and generate a projected requestor device queue for times corresponding to ETAs of candidate provider devices at a geographic area. Additionally or alternatively, the requestor device queue engine 502 can analyze a recent average transportation request rate, for example, to generate the projected requestor device queue for a future interval of time. In some embodiments, the requestor device queue engine 502 can communicate with a third-party server, for example, to obtain flight information or other data potentially affecting a requestor device queue.

The provider device queue manager 504 can obtain, send, receive, process, analyze and/or predict data corresponding to provider devices as described in relation to the foregoing figures. For example, the provider device queue manager 504 can determine a current provider device queue and generate a projected provider device queue for times corresponding to ETAs of candidate provider devices at a geographic area. Additionally or alternatively, the provider device queue manager 504 can communicate with the requestor device queue engine 502, for example, to generate the projected provider device queue based on a projected requestor device queue.

As also part of the flex forecasting pre-dispatch system 105, the ETA generator 506 can generate, determine, and/or obtain ETA data corresponding to provider devices at a geographic area as described in relation to the foregoing figures. For example, the ETA generator 506 may communicate with a third-party server to obtain ETA data based on a current location of a provider device relative to the geographic area. In some embodiments, the ETA generator 506 can generate ETA updates in real-time for one or more candidate provider devices and/or provider devices in-transit to the geographic area.

The dispatch decision engine 508 can obtain, send, receive, process, analyze and/or model data corresponding to provider device queues and requestor device queues as described in relation to the foregoing figures. For example, the dispatch decision engine 508 can compare a projected provider device queue to a queue capacity. If the projected provider device queue fails to comport with the queue capacity, the dispatch decision engine 508 may withhold pre-dispatching a corresponding candidate provider device (i.e., filter the candidate provider device). On the other hand, if the projected provider devices queue comports with (i.e., is less than) the queue capacity, the dispatch decision engine 508 may determine to pre-dispatch the given candidate provider device to the geographic area. In particular, the dispatch decision engine 508 can utilize a look-ahead model and a look-behind model to compare projected provider device queues to a queue capacity as described in relation to at least FIGS. 3C-3D.

As further part of the flex forecasting pre-dispatch system 105, the pre-dispatch model simulation manager 510 can obtain, send, receive, process, analyze, learn, modify, and/or simulate model parameters corresponding to pre-dispatch models as described in relation to the foregoing figures. For example, the pre-dispatch model simulation manager 510 can compare pre-dispatch models to generate simulated performance metrics. Based on the simulated performance metrics, the flex forecasting pre-dispatch system 105 can select a pre-dispatch model for implementing one or more aspects disclosed herein.

The data storage facility 512 maintains data for the flex forecasting pre-dispatch system 105. The data storage facility 512 (e.g., via one or more memory devices) can maintain data of any type, size, or kind, as necessary to perform the functions of the flex forecasting pre-dispatch system 105, including third-party data such as flight information, and so forth.

Each of the components of the computing device 500 can include software, hardware, or both. For example, the components of the computing device 500 can include one or more instructions stored on a computer-readable storage medium and executable by processors of one or more computing devices, such as a client device or server device. When executed by the one or more processors, the computer-executable instructions of the flex forecasting pre-dispatch system 105 can cause the computing device(s) (e.g., the computing device 500) to perform the methods described herein. Alternatively, the components of the computing device 500 can include hardware, such as a special-purpose processing device to perform a certain function or group of functions. Alternatively, the components of the computing device 500 can include a combination of computer-executable instructions and hardware.

Furthermore, the components of the computing device 500 may, for example, be implemented as one or more operating systems, as one or more stand-alone applications, as one or more modules of an application, as one or more plug-ins, as one or more library functions or functions that may be called by other applications, and/or as a cloud-computing model. Thus, the components of the computing device 500 may be implemented as a stand-alone application, such as a desktop or mobile application. Furthermore, the components of the computing device 500 may be implemented as one or more web-based applications hosted on a remote server.

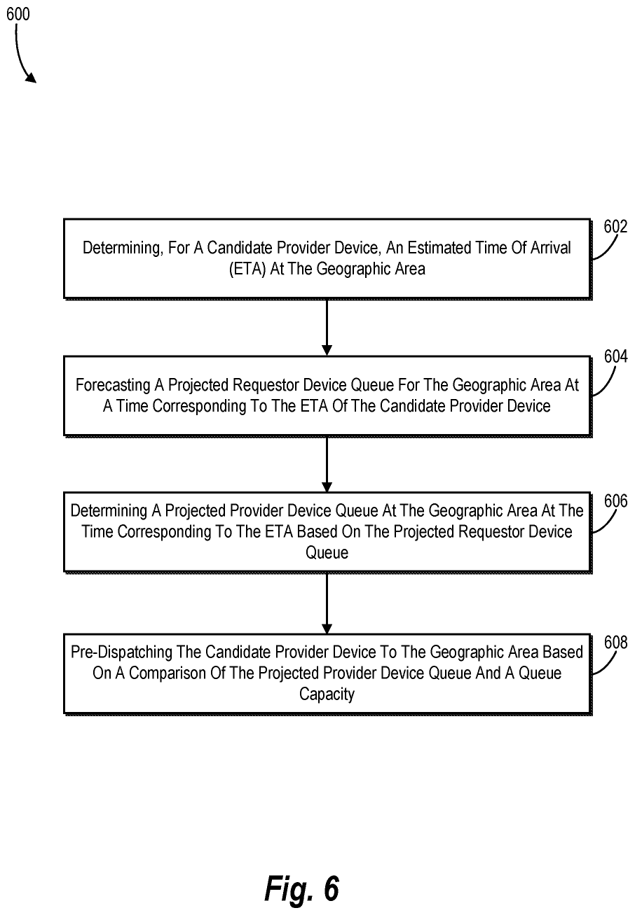

FIGS. 1-5, the corresponding text, and the examples provide several different systems, methods, techniques, components, and/or devices of the flex forecasting pre-dispatch system 105 in accordance with one or more embodiments. In addition to the above description, one or more embodiments can also be described in terms of flowcharts including acts for accomplishing a particular result. For example, FIG. 6 illustrates a flowchart of a series of acts 600 for pre-dispatching a candidate provider device to a geographic area in accordance with one or more embodiments. The flex forecasting pre-dispatch system 105 may perform one or more acts of the series of acts 600 in addition to or alternatively to one or more acts described in conjunction with other figures. While FIG. 6 illustrates acts according to one embodiment, alternative embodiments may omit, add to, reorder, and/or modify any of the acts shown in FIG. 6. The acts of FIG. 6 can be performed as part of a method. Alternatively, a non-transitory computer-readable medium can comprise instructions that, when executed by one or more processors, cause a computing device to perform the acts of FIG. 6. In some embodiments, a system can perform the acts of FIG. 6.

As shown, the series of acts 600 includes an act 602 of determining, for a candidate provider device, an estimated time of arrival (ETA) at the geographic area. The series of acts 600 further includes an act 604 of forecasting a projected requestor device queue for the geographic area at a time corresponding to the ETA of the candidate provider device. In some embodiments, forecasting the projected requestor device queue at act 604 comprises utilizing a requestor device forecasting model to predict, based on historical transportation request data, a number of requestor devices that will transmit transportation requests at a predetermined time.

In addition, the series of acts 600 includes an act 606 of determining a projected provider device queue at the geographic area at the time corresponding to the ETA based on the projected requestor device queue. The series of acts 600 further includes an act 608 of pre-dispatching the candidate provider device to the geographic area based on a comparison of the projected provider device queue and a queue capacity. In these or other embodiments, pre-dispatching the candidate provider device to the geographic area at act 608 comprises dispatching the candidate provider device to the geographic area prior to receiving a transportation request from a requestor device (or prior to determining a match between the provider device and the requestor device).

It is understood that the outlined acts in the series of acts 600 are only provided as examples, and some of the acts may be optional, combined into fewer acts, or expanded into additional acts without detracting from the essence of the disclosed embodiments. Additionally, the acts described herein may be repeated or performed in parallel with one another or in parallel with different instances of the same or similar acts. As an example of one or more additional or alternative acts not shown in FIG. 6, act(s) in the series of acts 600 may include: identifying a current requestor device queue at the geographic area, a current provider device queue comprising a number of provider devices positioned at the geographic area, and an in-transit provider device queue comprising a number of provider devices in transit to the geographic area; and forecasting the projected provider device queue at the geographic area at the time corresponding to the ETA based on the current requestor device queue, the current provider device queue, the in-transit provider device queue, and the projected requestor device queue.

As another example of one or more additional or alternative acts not shown in FIG. 6, act(s) in the series of acts 600 may include: determining, for an additional candidate provider device, an additional ETA at the geographic area that is less than the ETA for the candidate provider device; and pre-dispatching the additional candidate provider device utilizing a look-ahead model and a look-behind model.

In yet another example of one or more additional or alternative acts not shown in FIG. 6, act(s) in the series of acts 600 may include pre-dispatching the additional candidate provider device utilizing the look-ahead model by: forecasting an additional projected requestor device queue for the geographic area at a time corresponding to the additional ETA; forecasting an additional projected provider device queue at the time corresponding to the additional ETA based on the additional projected requestor device queue; and determining that the additional projected provider device queue is less than the queue capacity.

As another example of one or more additional or alternative acts not shown in FIG. 6, act(s) in the series of acts 600 may include pre-dispatching the additional candidate provider device utilizing the look-behind model by: determining a modified projected provider device queue for the geographic area at the time corresponding to the ETA of the candidate provider device based on pre-dispatching the additional candidate provider device; and determining that, in pre-dispatching the additional candidate provider device to the geographic area, the modified projected provider device queue for the geographic area at the time corresponding to the ETA of the candidate provider device is less than the queue capacity.

As another example of one or more additional or alternative acts not shown in FIG. 6, act(s) in the series of acts 600 may include executing a first simulation of the pre-dispatch model to generate a first set of simulated performance metrics; executing a second simulation of an additional pre-dispatch model to generate a second set of simulated performance metrics; and selecting the pre-dispatch model based on a comparison of the first set of simulated performance metrics and the second set of simulated performance metrics.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 7 illustrates a block diagram of an example computing device 700 that may be configured to perform one or more of the processes described above. One will appreciate that one or more computing devices, such as the computing device 700 may represent the computing devices described above (e.g., the computing device 500, the server(s) 102, the provider devices 106, requestor devices 110, the third-party server 116). In one or more embodiments, the computing device 700 may be a mobile device (e.g., a mobile telephone, a smartphone, a PDA, a tablet, a laptop, etc.). In some embodiments, the computing device 700 may be a non-mobile device (e.g., a desktop computer or another type of client device). Further, the computing device 700 may be a server device that includes cloud-based processing and storage capabilities.

As shown in FIG. 7, the computing device 700 can include one or more processor(s) 702, memory 704, a storage device 706, input/output interfaces 708 (or “I/O interfaces 708”), and a communication interface 710, which may be communicatively coupled by way of a communication infrastructure (e.g., bus 712). While the computing device 700 is shown in FIG. 7, the components illustrated in FIG. 7 are not intended to be limiting. Additional or alternative components may be used in other embodiments. Furthermore, in certain embodiments, the computing device 700 includes fewer components than those shown in FIG. 7. Components of the computing device 700 shown in FIG. 7 will now be described in additional detail.

In particular embodiments, the processor(s) 702 includes hardware for executing instructions, such as those making up a computer program. As an example, and not by way of limitation, to execute instructions, the processor(s) 702 may retrieve (or fetch) the instructions from an internal register, an internal cache, memory 704, or a storage device 706 and decode and execute them.

The computing device 700 includes memory 704, which is coupled to the processor(s) 702. The memory 704 may be used for storing data, metadata, and programs for execution by the processor(s). The memory 704 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 704 may be internal or distributed memory.

The computing device 700 includes a storage device 706 includes storage for storing data or instructions. As an example, and not by way of limitation, the storage device 706 can include a non-transitory storage medium described above. The storage device 706 may include a hard disk drive (HDD), flash memory, a Universal Serial Bus (USB) drive or a combination these or other storage devices.

As shown, the computing device 700 includes one or more I/O interfaces 708, which are provided to allow a user to provide input to (such as user strokes), receive output from, and otherwise transfer data to and from the computing device 700. These I/O interfaces 708 may include a mouse, keypad or a keyboard, a touch screen, camera, optical scanner, network interface, modem, other known I/O devices or a combination of such I/O interfaces 708. The touch screen may be activated with a stylus or a finger.

The I/O interfaces 708 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 708 are configured to provide graphical data to a display for presentation to a user. The graphical data may be representative of one or more graphical user interfaces and/or any other graphical content as may serve a particular implementation.

The computing device 700 can further include a communication interface 710. The communication interface 710 can include hardware, software, or both. The communication interface 710 provides one or more interfaces for communication (such as, for example, packet-based communication) between the computing device and one or more other computing devices or one or more networks. As an example, and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI. The computing device 700 can further include a bus 712. The bus 712 can include hardware, software, or both that connects components of the computing device 700 to each other.

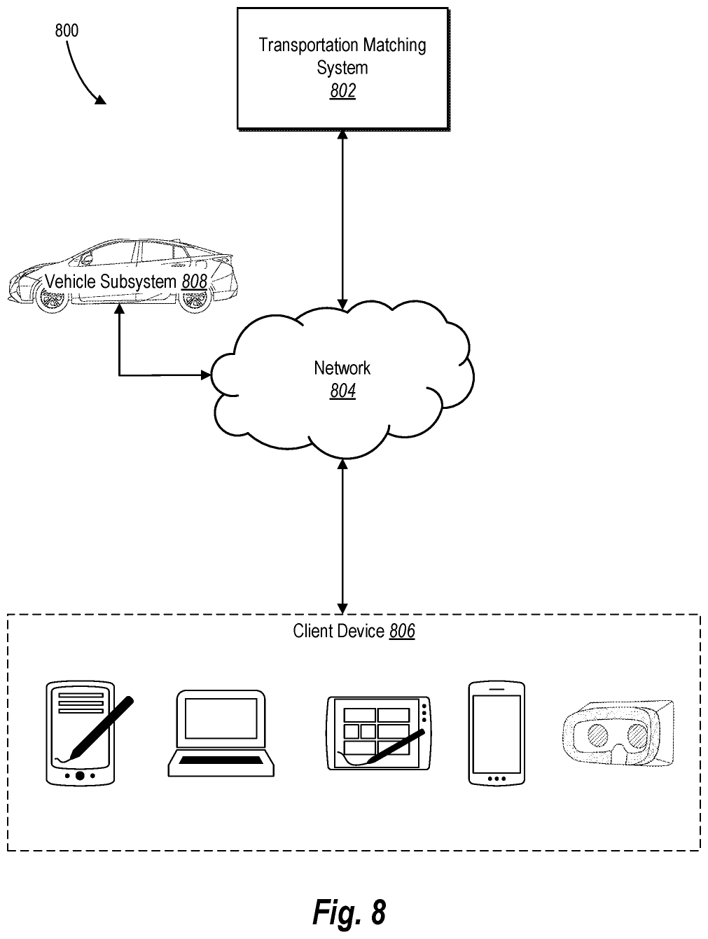

FIG. 8 illustrates an example network environment 800 of a transportation matching system (e.g., the dynamic transportation matching system 104) configured to implement one or more embodiments of the flex forecasting pre-dispatch system 105 as disclosed herein. The network environment 800 includes a client device 806, a transportation matching system 802, and a vehicle subsystem 808 connected to each other by a network 804. Although FIG. 8 illustrates a particular arrangement of the client device 806, the transportation matching system 802, the vehicle subsystem 808, and the network 804, this disclosure contemplates any suitable arrangement of the client device 806, the transportation matching system 802, the vehicle subsystem 808, and the network 804. As an example, and not by way of limitation, two or more of the client devices 806, the transportation matching system 802, and the vehicle subsystem 808 communicate directly, bypassing the network 804. As another example, two or more of the client devices 806, the transportation matching system 802, and the vehicle subsystem 808 may be physically or logically co-located with each other in whole or in part. Moreover, although FIG. 8 illustrates a particular number of the client devices 806, the transportation matching systems 802, the vehicle subsystems 808, and the networks 804, this disclosure contemplates any suitable number of the client devices 806, the transportation matching systems 802, the vehicle subsystems 808, and the networks 804. As an example, and not by way of limitation, the network environment 800 may include multiple client devices 806, the transportation matching systems 802, the vehicle subsystems 808, and the networks 804.

This disclosure contemplates any suitable network 804. As an example, and not by way of limitation, one or more portions of the network 804 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. The network 804 may include one or more networks 804.

Links may connect the client device 806, the transportation matching system 802, and the vehicle subsystem 808 to the communication network 804 or to each other. This disclosure contemplates any suitable links. In particular embodiments, one or more links include one or more wireline (such as for example Digital Subscriber Line (DSL) or Data Over Cable Service Interface Specification (DOCSIS), wireless (such as for example Wi-Fi or Worldwide Interoperability for Microwave Access (WiMAX), or optical (such as for example Synchronous Optical Network (SONET) or Synchronous Digital Hierarchy (SDH) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout the network environment 800. One or more first links may differ in one or more respects from one or more second links.

In particular embodiments, the client device 806 may be an electronic device including hardware, software, or embedded logic components or a combination of two or more such components and capable of carrying out the appropriate functionalities implemented or supported by the client device 806. As an example, and not by way of limitation, a client device 806 may include any of the computing devices discussed above in relation to FIG. 8. A client device 806 may enable a network user at the client device 806 to access a network. A client device 806 may enable its user to communicate with other users at other client devices 806.

In particular embodiments, the client device 806 may include a transportation service application or a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at the client device 806 may enter a Uniform Resource Locator (URL) or other address directing the web browser to a particular server (such as server), and the web browser may generate a Hyper Text Transfer Protocol (HTTP) request and communicate the HTTP request to server. The server may accept the HTTP request and communicate to client device 806 one or more Hyper Text Markup Language (HTML) files responsive to the HTTP request. The client device 806 may render a webpage based on the HTML files from the server for presentation to the user. This disclosure contemplates any suitable webpage files. As an example, and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, the transportation matching system 802 may be a network-addressable computing system that can host a ride share transportation network. The transportation matching system 802 may generate, store, receive, and send data, such as, for example, user-profile data, concept-profile data, text data, ride request data, GPS location data, provider data, requestor data, vehicle data, or other suitable data related to the ride share transportation network. This may include authenticating the identity of providers and/or vehicles who are authorized to provide ride services through the transportation matching system 802. In addition, the transportation service system may manage identities of service requestors such as users/requestors. In particular, the transportation service system may maintain requestor data such as driving/riding histories, personal data, or other user data in addition to navigation and/or traffic management services or other location services (e.g., GPS services).

In particular embodiments, the transportation matching system 802 may manage ride matching services to connect a user/requestor with a vehicle and/or provider. By managing the ride matching services, the transportation matching system 802 can manage the distribution and allocation of vehicle subsystem resources and user resources such as GPS location and availability indicators, as described herein.

The transportation matching system 802 may be accessed by the other components of the network environment 800 either directly or via network 804. In particular embodiments, the transportation matching system 802 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the transportation matching system 802 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 806, or a transportation matching system 802 to manage, retrieve, modify, add, or delete, the information stored in data store.

In particular embodiments, the transportation matching system 802 may provide users with the ability to take actions on various types of items or objects, supported by the transportation matching system 802. As an example, and not by way of limitation, the items and objects may include ride share networks to which users of the transportation matching system 802 may belong, vehicles that users may request, location designators, computer-based applications that a user may use, transactions that allow users to buy or sell items via the service, interactions with advertisements that a user may perform, or other suitable items or objects. A user may interact with anything that is capable of being represented in the transportation matching system 802 or by an external system of a third-party system, which is separate from the transportation matching system 802 and coupled to the transportation matching system 802 via a network 804.

In particular embodiments, the transportation matching system 802 may be capable of linking a variety of entities. As an example, and not by way of limitation, the transportation matching system 802 may enable users to interact with each other or other entities, or to allow users to interact with these entities through an application programming interfaces (API) or other communication channels.

In particular embodiments, the transportation matching system 802 may include a variety of servers, sub-systems, programs, modules, logs, and data stores. In particular embodiments, the transportation matching system 802 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The transportation matching system 802 may also include suitable components such as network interfaces, security mechanisms, load balancers, failover servers, management-and-network-operations consoles, other suitable components, or any suitable combination thereof. In particular embodiments, the transportation matching system 802 may include one or more user-profile stores for storing user profiles. A user profile may include, for example, biographic information, demographic information, behavioral information, social information, or other types of descriptive information, such as work experience, educational history, hobbies or preferences, interests, affinities, or location.

The web server may include a mail server or other messaging functionality for receiving and routing messages between the transportation matching system 802 and one or more client devices 806. An action logger may be used to receive communications from a web server about a user's actions on or off the transportation matching system 802. In conjunction with the action log, a third-party-content-object log may be maintained of user exposures to third-party-content objects. A notification controller may provide information regarding content objects to a client device 806. Information may be pushed to a client device 806 as notifications, or information may be pulled from the client device 806 responsive to a request received from the client device 806. Authorization servers may be used to enforce one or more privacy settings of the users of the transportation matching system 802. A privacy setting of a user determines how particular information associated with a user can be shared. The authorization server may allow users to opt in to or opt out of having their actions logged by the transportation matching system 802 or shared with other systems, such as, for example, by setting appropriate privacy settings. Third-party-content-object stores may be used to store content objects received from third parties. Location stores may be used for storing location information received from the client devices 806 associated with users.

In addition, the vehicle subsystem 808 can include a human-operated vehicle or an autonomous vehicle. A provider of a human-operated vehicle can perform maneuvers to pick up, transport, and drop off one or more requestors according to the embodiments described herein. In certain embodiments, the vehicle subsystem 808 can include an autonomous vehicle—i.e., a vehicle that does not require a human operator. In these embodiments, the vehicle subsystem 808 can perform maneuvers, communicate, and otherwise function without the aid of a human provider, in accordance with available technology.

In particular embodiments, the vehicle subsystem 808 may include one or more sensors incorporated therein or associated thereto. For example, sensor(s) can be mounted on the top of the vehicle subsystem 808 or else can be located within the interior of the vehicle subsystem 808. In certain embodiments, the sensor(s) can be located in multiple areas at once—i.e., split up throughout the vehicle subsystem 808 so that different components of the sensor(s) can be placed in different locations in accordance with optimal operation of the sensor(s). In these embodiments, the sensor(s) can include a LIDAR sensor and an inertial measurement unit (IMU) including one or more accelerometers, one or more gyroscopes, and one or more magnetometers. The sensor suite can additionally or alternatively include a wireless IMU (WIMU), one or more cameras, one or more microphones, or other sensors or data input devices capable of receiving and/or recording information relating to navigating a route to pick up, transport, and/or drop off a requestor.

In particular embodiments, the vehicle subsystem 808 may include a communication device capable of communicating with the client device 806 and/or the transportation matching system 802. For example, the vehicle subsystem 808 can include an on-board computing device communicatively linked to the network 804 to transmit and receive data such as GPS location information, sensor-related information, requestor location information, or other relevant information.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising, utilizing a pre-dispatch model to position candidate provider devices at a geographic area corresponding to requestor devices by:
determining, for a candidate provider device, an estimated time of arrival (ETA) at the geographic area;
forecasting a projected requestor device queue for the geographic area at a time corresponding to the ETA of the candidate provider device;
forecasting a projected provider device queue at the geographic area at the time corresponding to the ETA based on the projected requestor device queue; and
pre-dispatching the candidate provider device to the geographic area based on a comparison of the projected provider device queue and a queue capacity.

2. The computer-implemented method of claim 1, further comprising:
identifying a current requestor device queue at the geographic area, a current provider device queue comprising a number of provider devices positioned at the geographic area, and an in-transit provider device queue comprising a number of provider devices in transit to the geographic area; and
forecasting the projected provider device queue at the time corresponding to the ETA based on the current requestor device queue, the current provider device queue, the in-transit provider device queue, and the projected requestor device queue.

3. The computer-implemented method of claim 2, further comprising:
determining, for an additional candidate provider device, an additional ETA at the geographic area that is less than the ETA for the candidate provider device; and
pre-dispatching the additional candidate provider device utilizing a look-ahead model and a look-behind model.

4. The computer-implemented method of claim 3, wherein pre-dispatching the additional candidate provider device utilizing the look-ahead model comprises:
forecasting an additional projected requestor device queue for the geographic area at a time corresponding to the additional ETA;
forecasting an additional projected provider device queue at the time corresponding to the additional ETA based on the additional projected requestor device queue; and
determining that the additional projected provider device queue is less than the queue capacity.

5. The computer-implemented method of claim 3, wherein pre-dispatching the additional candidate provider device utilizing the look-behind model comprises:
determining a modified projected provider device queue for the geographic area at the time corresponding to the ETA of the candidate provider device based on pre-dispatching the additional candidate provider device; and
determining that, in pre-dispatching the additional candidate provider device to the geographic area, the modified projected provider device queue for the geographic area at the time corresponding to the ETA of the candidate provider device is less than the queue capacity.

6. The computer-implemented method of claim 1, further comprising:
executing a first simulation of the pre-dispatch model to generate a first set of simulated performance metrics;
executing a second simulation of an additional pre-dispatch model to generate a second set of simulated performance metrics; and
selecting the pre-dispatch model based on a comparison of the first set of simulated performance metrics and the second set of simulated performance metrics.

7. The computer-implemented method of claim 1, wherein pre-dispatching the candidate provider device to the geographic area comprises dispatching the candidate provider device to the geographic area prior to receiving a transportation request from a requestor device corresponding to the provider device.

8. The computer-implemented method of claim 1, wherein forecasting the projected requestor device queue comprises utilizing a requestor device forecasting model to predict, based on historical transportation request data, a number of requestor devices that will transmit transportation requests.

9. A non-transitory computer-readable medium comprising instructions that, when executed by at least one processor, cause a computer system to, utilize a pre-dispatch model to position candidate provider devices at a geographic area corresponding to requestor devices by:
determining, for a candidate provider device, an estimated time of arrival (ETA) at the geographic area;
forecast a projected requestor device queue for the geographic area at a time corresponding to the ETA of the candidate provider device;
forecast a projected provider device queue at the geographic area at the time corresponding to the ETA based on the projected requestor device queue; and
pre-dispatching the candidate provider device to the geographic area based on a comparison of the projected provider device queue and a queue capacity.

10. The non-transitory computer-readable medium of claim 9, further comprising instructions that, when executed by the at least one processor, cause the computer system to:
identify a current requestor device queue at the geographic area, a current provider device queue comprising a number of provider devices positioned at the geographic area, and an in-transit provider device queue comprising a number of provider devices in transit to the geographic area; and
forecast the projected provider device queue at the time corresponding to the ETA based on the current requestor device queue, the current provider device queue, in-transit provider device queue, and the projected requestor device queue.

11. The non-transitory computer-readable medium of claim 10, further comprising instructions that, when executed by the at least one processor, cause the computer system to:
determine, for an additional candidate provider device, an additional ETA at the geographic area that is less than the ETA for the candidate provider device; and
pre-dispatch the additional candidate provider device utilizing a look-ahead model and a look-behind model.

12. The non-transitory computer-readable medium of claim 11, further comprising instructions that, when executed by the at least one processor, cause the computer system to pre-dispatch the additional candidate provider device utilizing the look-ahead model by:
forecasting an additional projected requestor device queue for the geographic area at a time corresponding to the additional ETA;
forecasting an additional projected provider device queue at the time corresponding to the additional ETA based on the additional projected requestor device queue; and
determining that the additional projected provider device queue is less than the queue capacity.

13. The non-transitory computer-readable medium of claim 11, further comprising instructions that, when executed by the at least one processor, cause the computer system to pre-dispatch the additional candidate provider device utilizing the look-behind model by:
determining a modified projected provider device queue for the geographic area at the time corresponding to the ETA of the candidate provider device based on pre-dispatching the additional candidate provider device; and
determining that, in pre-dispatching the additional candidate provider device to the geographic area, the modified projected provider device queue for the geographic area at the time corresponding to the ETA of the candidate provider device is less than the queue capacity.

14. The non-transitory computer-readable medium of claim 9, further comprising instructions that, when executed by the at least one processor, cause the computer system to:
execute a first simulation of the pre-dispatch model to generate a first set of simulated performance metrics;
execute a second simulation of an additional pre-dispatch model to generate a second set of simulated performance metrics; and
select the pre-dispatch model based on a comparison of the first set of simulated performance metrics and the second set of simulated performance metrics.

15. The non-transitory computer-readable medium of claim 9, further comprising instructions that, when executed by the at least one processor, cause the computer system to pre-dispatch the candidate provider device to the geographic area by dispatching the candidate provider device to the geographic area prior to receiving a transportation request from a requestor device.

16. A system comprising:
one or more memory devices comprising a pre-dispatch model to position candidate provider devices at a geographic area corresponding to requestor devices; and
one or more computing devices configured to cause the system to:
determine, for a candidate provider device, an estimated time of arrival (ETA) at the geographic area;
forecast a projected requestor device queue for the geographic area at a time corresponding to the ETA of the candidate provider device;
forecast a projected provider device queue at the geographic area at the time corresponding to the ETA based on the projected requestor device queue; and
pre-dispatch the candidate provider device to the geographic area based on a comparison of the projected provider device queue and a queue capacity.

17. The system of claim 16, wherein the one or more computing devices are further configured to cause the system to:
identify a current requestor device queue at the geographic area, a current provider device queue comprising a number of provider devices positioned at the geographic area, and an in-transit provider device queue comprising a number of provider devices in transit to the geographic area; and
forecast the projected provider device queue at the time corresponding to the ETA based on the current requestor device queue, the current provider device queue, the in-transit provider device queue, and the projected requestor device queue.

18. The system of claim 17, wherein the one or more computing devices are further configured to cause the system to:
determine, for an additional candidate provider device, an additional ETA at the geographic area that is less than the ETA for the candidate provider device; and
pre-dispatch the additional candidate provider device utilizing a look-ahead model and a look-behind model.

19. The system of claim 18, wherein the one or more computing devices are further configured to cause the system to pre-dispatch the additional candidate provider device utilizing the look-ahead model by:
forecasting an additional projected requestor device queue for the geographic area at a time corresponding to the additional ETA of the additional candidate provider device;
forecasting an additional projected provider device queue at the time corresponding to the additional ETA based on the additional projected requestor device queue; and
determining that the additional projected provider device queue is less than the queue capacity.

20. The system of claim 18, wherein the one or more computing devices are further configured to cause the system to pre-dispatch the additional candidate provider device utilizing the look-behind model by:
determining a modified projected provider device queue for the geographic area at the time corresponding to the ETA of the candidate provider device based on pre-dispatching the additional candidate provider device; and
determining that, in pre-dispatching the additional candidate provider device to the geographic area, the modified projected provider device queue for the geographic area at the time corresponding to the ETA of the candidate provider device is less than the queue capacity.
